(19) United States
(12) Patent Application Publication
(10) Pub. No.: US 2020/0219360 A1
(43) Pub. Date: Jul. 9, 2020

(54) Dice Game as a Combination Game

(71) Applicant: Gamblit Gaming, LLC, Glendale, CA (US)

(72) Inventors: Miles Arnone, Cambridge, MA (US); Eric Meyerhofer, Pasadena, CA (US); Frank Cire, Pasadena, CA (US)

(21) Appl. No.: 16/736,770

(22) Filed: Jan. 7, 2020

Related U.S. Application Data
(63) Continuation of application No. 16/042,493, filed on Jul. 23, 2018, now Pat. No. 10,529,177.
Application No. 16/042,493 is a continuation of application No. 14/942,844, filed on Nov. 16, 2015, now Pat. No. 10,032,330.
Application No. 14/942,844 is a continuation of application No. PCT/US2014/037803, filed on May 13, 2014.
(60) Provisional application No. 61/823,051, filed on May 14, 2013.

(51) Int. Cl. G07F 17/32

(52) U.S. Cl. CPC G07F 17/3223; A63F 2003/00996; G07F 17/326; G07F 17/3286

(57) ABSTRACT

A gambling hybrid game with a gambling integrated game is disclosed. The gambling hybrid game includes a mobile device that provides a dice game as an entertainment game to a user, a real world engine that provides gambling games to one or more users, and a game world engine that monitors the entertainment game and provides gambling games when appropriate. When a die roll event occurs in the dice game, the mobile device resolves the die roll event and provides the results of the die roll event to the game world engine. The game world engine receives the results of the die roll event and determines gambling results based upon the results of the die roll event.

### CROSS-REFERENCE TO RELATED APPLICATIONS

The current application is a continuation of U.S. patent application Ser. No. 16/042,493, filed Jul. 23, 2018, which is a continuation of U.S. patent application Ser. No. 14/942,844, filed Nov. 16, 2015, which is a continuation of Patent Cooperation Treaty Application No. PCT/US14/37803, filed May 13, 2014, which claims the benefit of US Provisional Application No. 61/823,051, filed May 14, 2013, the disclosures of each of which are incorporated herein by reference as if set forth herewith.

### FIELD OF THE INVENTION

Embodiments of the present invention are generally related to gaming and more specifically to systems and processes that enhance a gambling process in a gambling game based upon random events that occur in a dice game provided as an entertainment game.

### BACKGROUND

The gaming machine manufacturing industry provides a variety of gaming machines to enable wagering for interested parties whilst providing an entertainment experience. An exemplary gaming machine is a slot machine. As the demographic of eligible players has shifted with time to newer generations who have grown accustomed to highly sophisticated graphics and interactive video games, a need has arisen to increase the entertainment content present on a gaming machine to keep it relevant, at least to a growing portion of a casino's patronage. The subject design is a form of gaming machine, designed for use in a physical or virtual casino environment, which provides players an environment in which to play for cash, prizes and points, either against the casino or in head to head modes in a controlled and regulated manner while being allowed to use their skills and adeptness at a particular type of game. An example of such a game would be a challenging word spelling game, or an interactive action game such as is found on video game consoles popular today, such as a PlayStation®, an Xbox®, a Wii® or a PC based game.

### SUMMARY OF THE INVENTION

The disclosed embodiments relate generally to an interactive entertainment game where skill and chance may coalesce to provide a rich arcade-style gaming experience, visually exciting and challenging, where players may wager cash, credits prizes and points in order to win more of the foregoing. Many of the embodiments of the design provide an enticing method of gaming to the players who expect a high level of entertainment content in their gaming experience compared to the relatively simple game methods in use today.

In accordance with embodiments of this invention, a system for providing a gambling hybrid game including a gambling integrated game that provides a dice game as an entertainment game, including a currency input device, where a player inserts money to enable play of the gambling hybrid game; a processing device, connected to a game world server via a network, constructed to execute the dice game as the entertainment game; resolve a die roll event to generate a die roll event result wherein the die roll event includes a roll of one or more die; communicate, to the game world server via the network, a signal including the die roll event result and an occurrence of a gambling event in a gambling game based on play of the entertainment game; receive, from the game world server via the network, a signal including a result of the gambling event; and display, to the player, the result of the gambling event; a real world server, connected to the game world server via a communication link, constructed to receive, from the game world server via the communication link, a signal including a request for a resolution of the gambling event and the die roll event result; determine a result of the gambling event based on the die roll event result; and communicate, to the game world server via the communication link, the signal including the result of the gambling event; and the game world server, connected to the processing device via the network and connected to the real world server via the communication link, constructed to: manage the entertainment game; monitor the processing device for the signal including the die roll event result and an occurrence of a gambling event in a gambling game based on play of the entertainment game; receive, from the processing device via the network, the signal including the die roll event result and the occurrence of the gambling event in the gambling game based on play of the entertainment game; communicate, to the real world server via the communication link, the signal including the request for the resolution of the gambling event and the die roll event results; receive, from the real world server via the communication link, the signal including the result of the gambling event; and communicate, to the processing device via the network, the signal including the result of the gambling event.

In accordance with many embodiments of the invention, the processing device is further constructed to detect the die roll event is to occur during execution of the dice game; communicate, to the game world server via the network, a signal including a request for gambling information for the die roll event; receive, from the game world server via the network, a signal including the gambling information for the die roll event; and display the gambling information to the player during execution of the dice game.

In accordance with numerous embodiments of the invention, the game world server is further constructed to generate the gambling information for the die roll event.

In accordance with various embodiments of the invention, the real world server is further constructed to receive, from the game world server via the communication link, the signal including a request for a gambling information for the die roll event; determine the gambling information for the die roll event; and communicate, to the game world server via the communication link, the signal including the gambling information for the die roll event.

In accordance with many embodiments of the invention, the die roll event includes a plurality of rolls of one or more die and the processing device determines a current roll result for each of the plurality of die rolls in the dice roll event during execution of the dice game and the game world server uses the current roll result for each of the plurality of rolls to determine a gambling result based upon the die roll event.

In accordance with various embodiments of the invention, the processing device is further constructed to determine the current roll result for one of the plurality of rolls of the die event; communicate, to the game world server via the network, a signal including the current roll result; and receive from the game world server via the network, a signal including the update of the gambling information.

In accordance with many embodiments of the invention, the game world server is further constructed to determine an update of the gambling information based upon the current roll result; and communicate, to the processing device via the network, the signal including the update of the gambling information.

### BRIEF DESCRIPTION OF THE DRAWINGS

FIG. 1 illustrates a conceptual diagram of components of a gambling hybrid game in accordance with an embodiment of the invention.

FIG. 2 illustrates a conceptual diagram of aspects of a Real World Engine (RWE) of a gambling hybrid game in accordance with some embodiments of the invention.

FIG. 3 illustrates a conceptual diagram of aspects of a Real World Engine (RWE) of a gambling hybrid game in accordance with some other embodiments of the invention.

FIG. 4 illustrates a signaling diagram of communications between a Real World Engine (RWE) and an external system to provide various functions in accordance with embodiments of the invention.

FIG. 5 illustrates a diagram of a process flow and signaling in a Real World Engine (RWE) to provide various functions in accordance with embodiments of the invention.

FIG. 6 illustrates a conceptual diagram of aspects of an Entertainment System Engine (ESE) in accordance with embodiments of the invention.

FIG. 7 illustrates a conceptual diagram of interactions between a user and a gambling hybrid game in accordance with embodiments of the invention.

FIG. 8 illustrates a conceptual diagram of the interplay between aspects of a gambling hybrid game in accordance with some embodiments of the invention using Real World Currency (RC).

FIG. 9 illustrates a conceptual diagram of the interplay between aspects of a gambling hybrid game in accordance with other embodiments of the invention using Virtual Real World Currency (VRC).

FIG. 10 illustrates a system diagram of an implementation of a network based gambling hybrid game in accordance with another embodiment of the invention.

FIG. 11 illustrates a system diagram of an implementation of an Internet based gambling hybrid game in accordance with an embodiment of the invention.

FIG. 12 illustrates a system diagram of an implementation of a cloud based gambling hybrid game in accordance with an embodiment of the invention.

FIG. 13 illustrates a block diagram of components of a device implementing a gambling hybrid game in accordance with an embodiment of the invention.

FIG. 14 illustrates a flow diagram of a gambling hybrid game with a gambling integrated game in accordance with an embodiment of the invention.

FIG. 15 illustrates a timing chart showing components of a gambling hybrid game providing a gambling integrated game of a dice game in accordance with an embodiment of the invention.

FIG. 16 illustrates a flow diagram of a process performed by an entertainment system engine to provide a gambling hybrid game including a gambling integrated game of a dice game in accordance with an embodiment of the invention.

FIG. 17 illustrates a flow diagram of a process performed by a game world engine to provide a gambling hybrid game including a gambling integrated game of a dice game in accordance with an embodiment of the invention.

FIG. 18 illustrates a flow diagram of a process performed by a real world engine to provide a gambling hybrid game including a gambling integrated game of a dice game in accordance with an embodiment of the invention.

FIGS. 19A to 19G Illustrate dice configurations in accordance with an embodiment of the invention.

### DETAILED DISCLOSURE OF THE INVENTION

Turning now to the drawings, systems and methods for providing a gambling hybrid game with a gambling integrated dice game are illustrated. A gambling integrated game is a game in which results from a random event in an entertainment game are used to determine the results of events in a gambling game. Examples of random events in an entertainment game include, but are not limited to, the drawing of cards, die rolls, the selection of a game piece from a pool of pieces, and a spin of a wheel. In accordance with some embodiments of the invention, the results of a roll of a die or more than one dice in the dice game provided as an entertainment game may determine payouts of wagers in a gambling game. In accordance with many embodiments of the invention, the roll of the die or dice in a dice game provided as the entertainment game may be a gambling event in a gambling game and the results of the die or dice roll in the dice game may be used to determine payouts to a player in terms of real world credits, in-game objects of the entertainment game, alteration of in-game variables of the entertainment game and/or allocation of credits to one or more pools being collected by the game operator.

Systems and methods for providing a gambling hybrid game with a gambling integrated game based upon a dice game in accordance with embodiments of this invention are described below with reference to the provided drawings.

### Gambling Hybrid Games

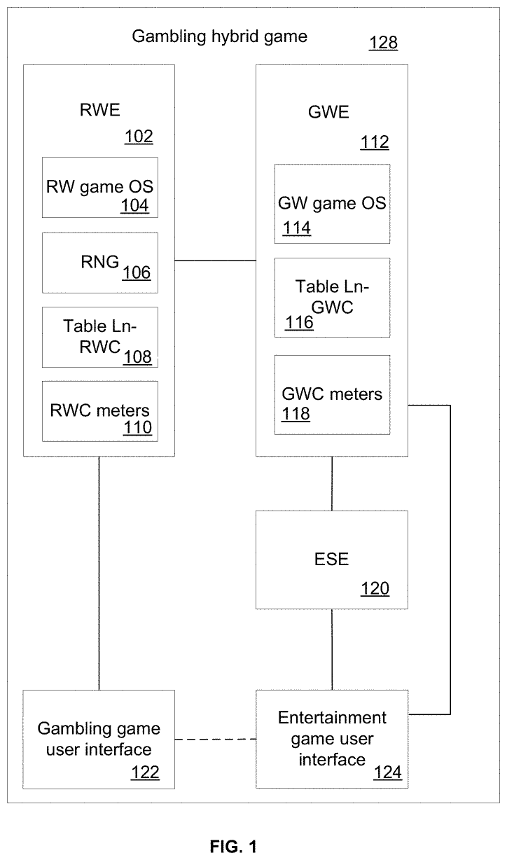

In accordance with many embodiments of this invention, a gambling hybrid game integrates high-levels of entertainment content with a game of skill (an entertainment game) and a gambling experience with a game of chance (a gambling game). A gambling hybrid game provides for random outcomes independent of player skill while providing that the user's gaming experience (as measured by obstacles/challenges encountered, time of play and other factors) is shaped by the player's skill. The outcome of a gambling proposition that is determined by a Random Number Generator (RNG) or other such device that provides a random outcome in response to a request. In accordance with some embodiments, the wager game may be initiated in response to a game object related player action. A gambling hybrid game in accordance with an embodiment of the invention is illustrated in FIG. 1. The gambling hybrid game 128 includes a Real World Engine (RWE) 102, a Game World Engine (GWE) 112, an Entertainment System Engine (ESE) 120, a gambling game user interface 122 and an entertainment game user interface 124. The two user interfaces can be part of the same user interface but are separate in the illustrated embodiment. The RWE 102 is connected with the GWE 112 and the gambling game user interface 122. The ESE 120 is connected with the GWE 112 and the entertainment game user interface 124. The GWE 112 is connected also with the entertainment game user interface 124.

In accordance with several embodiments, the RWE 102 is the operating system for the gambling game of the gambling hybrid game 128 and controls and operates the gambling game. The operation of a gambling game is enabled by Real World Currency (RC), such as money or other real world funds. A gambling game can increase or decrease an amount of RC based on random gambling results, where the gambling proposition of a gambling game is typically regulated by gaming control bodies. In many embodiments, the RWE 102 includes a Real World (RW) operating system (OS) 104, RNG 106, level n real-world credit pay tables (Table Ln-RC) 108, RC meters 110 and other software constructs that enable a game of chance to offer a fair and transparent gambling proposition, and to contain the auditable systems and functions that can enable the game to obtain gaming regulatory body approval.

A random number generator (RNG) 106 includes software and/or hardware algorithms and/or processes, which are used to generate random outcomes. A level n real-world credit pay table (Table Ln-RC) 108 is a table that can be used in conjunction with a Random Number Generator (RNG) 106 to dictate the RC earned as a function of sponsored gameplay and is analogous to the pay tables used in a conventional slot machine. Table Ln-RC payouts are independent of player skill. There can be one table or multiple tables included in Ln-RC pay tables 108 contained in a gambling game, the selection of which can be determined by factors including (but not limited to) game progress that a player has earned, and/or bonus rounds for which a player can be eligible. RCs are credits analogous to slot machine game credits, which are entered into a gambling game by the user, either in the form of money such as hard currency or electronic funds. RCs can be decremented or augmented based on the outcome of a random number generator according to the table Ln-RC real world credits pay table 108, independent of player skill. In certain embodiments, an amount of RC can be used as criteria in order to enter higher ESE game levels. RC can be carried forward to higher game levels or paid out if a cash out is opted for by a player. The amount of RC used to enter a specific level of the game, level n, need not be the same for each level.

In accordance with some embodiments of this invention, the GWE 112 manages the overall gambling hybrid game operation, with the RWE 102 and the ESE 120 effectively being support units to the GWE 112. In accordance with some of these embodiments, the GWE 112 contains mechanical, electronic, and software systems for an entertainment game. The GWE 112 includes an Operating System (OS) 114 that provides control of the entertainment game. The GWE additionally contains a level n game world credit pay table (table Ln-GWC) 116 from where to take input from this table to affect the play of the entertainment game. The GWE 112 can further couple to the RWE 102 to determine the amount of RC available on the game and other metrics of wagering on the gambling game (and potentially affect the amount of RC in play on the RWE). The GWE additionally contains various audit logs and activity meters (such as the GWC meter) 118. The GWE 112 can also couple to a centralized server for exchanging various data related to the player and his or her activities in the game. The GWE 112 furthermore couples to the ESE 120.

In accordance with some embodiments, a level n game world credit pay table (Table Ln-GWC) 116 dictates the Game World Credit (GWC) earned as a function of player skill in the nth level of the game. The payouts governed by this table are dependent upon player skill and sponsored gameplay at large and can or cannot be coupled to a RNG. In accordance with some embodiments, GWCs are player points earned or depleted as a function of player skill, specifically as a function of player performance in the context of the entertainment game. GWC is analogous to the score in a typical video game. Each entertainment game has one or more scoring criterion, embedded within the table Ln-GWC 116 that reflects player performance against the goal(s) of the game. GWCs can be carried forward from one level of sponsored gameplay to another, and ultimately paid out in various manners such as directly in cash, or indirectly such as by earning entrance into a sweepstakes drawing, or earning participation in, or victory in, a tournament with prizes. GWCs can be stored on a player tracking card or in a network-based player tracking system, where the GWCs are attributed to a specific player.

In accordance with certain embodiments, the operation of the GWE does not affect the RWE's gambling operation except for player choice parameters that are allowable in slot machines, including but not limited to, wager terms such as, but not limited to, a wager amount, how fast the player wants to play (by pressing a button or pulling the handle of a slot machine), and/or agreement to wager into a bonus round. In this sense, the RWE 102 provides a fair and transparent, non-skill based gambling proposition co-processor to the GWE 112. In the illustrated embodiment, the communication link shown between the GWE 112 and the RWE 102 allows the GWE 112 to obtain information from the RWE 102 as to the amount of RC available in the gambling game. The communication link can also convey a status operation of the RWE (such as on-line or tilt). The communication link can further communicate the various gambling control factors which the RWE 102 uses as input, such as the number of RC consumed per game or the player's election to enter a jackpot round. In FIG. 1, the GWE 112 is also shown as connecting to the player's user interface directly, as this can be utilized to communicate certain entertainment game club points, player status, control the selection of choices and messages which a player can find useful in order to adjust the entertainment game experience or understand their gambling status in the RWE 102.

In accordance with various embodiments of this invention, the ESE 120 manages and controls the visual, audio, and player control for the entertainment game. In accordance with certain embodiments, the ESE 120 accepts input from a player through a set of hand controls, and/or head, gesture, and/or eye tracking systems and outputs video, audio and/or other sensory output to a user interface. In accordance with many embodiments, the ESE 120 can exchange data with and accept control information from the GWE 112. In accordance with some of these embodiments, an ESE 120 can be implemented using a Personal Computer (PC), a Sony PlayStation® (a video game console developed by Sony Computer Entertainment of Tokyo Japan), or Microsoft Xbox® (a video game console developed by Microsoft Corporation of Redmond, Wash.) running a specific entertainment game software program. In accordance with some of these embodiments, ESE 120 can be an electromechanical game system of a gambling hybrid game that is an electromechanical hybrid game. An electromechanical hybrid game executes an electromechanical game for player entertainment. The electromechanical game can be any game that utilizes both mechanical and electrical components, where the game operates as a combination of mechanical motions performed by at least one player or the electromechanical game itself. Various electromechanical hybrid games are discussed in Patent Cooperation Treaty Application No. PCT/US12/58156, filed Sep. 29, 2012, the contents of which are hereby incorporated by reference in their entirety.

The ESE 120 operates mostly independently from the GWE 112, except that via the interface, the GWE 112 can send certain entertainment game control parameters and elements to the ESE 120 to affect its play, such as (but not limited to) what level of character to be using, changing the difficulty level of the game, changing the type of gun or car in use, and/or requesting potions to become available or to be found by the character. These game control parameters and elements can be based on a gambling result of a gambling game that was triggered by an element in the entertainment game being acted upon by the player. The ESE 120 can accept this input from the GWE 112, make adjustments, and continue entertainment game gameplay all the while running seamlessly from the player's perspective. The ESE's operation is mostly skill based, except for where the ESE's processes can inject complexities into the game by chance in its normal operation to create unpredictability in the entertainment game. Utilizing this interface, the ESE 120 can also communicate player choices made in the game to the GWE 112, such as but not limited to selection of a different gun, and/or the player picking up a special potion in the GW environment. The GWE's function in this architecture, being interfaced with the ESE 120, is to allow the transparent coupling of entertainment software to a fair and transparent random chance gambling game, providing a seamless perspective to the player that they are playing a typical popular entertainment game (which is skill based). In accordance with certain embodiments, the ESE 120 can be used to enable a wide range of entertainment games including but not limited to popular titles from arcade and home video games, such as but not limited to Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.). Providers of such software can provide the previously described interface by which the GWE 120 can request amendments to the operation of the ESE software in order to provide seamless and sensible operation as both a gambling game and an entertainment game.

In accordance with some embodiments, the RWE 102 can accept a trigger to run a gambling game in response to actions taken by the player in the entertainment game as conveyed by the ESE 120 to the GWE 112, or as triggered by the GWE 112 based on its algorithms, background to the overall game from the player's perspective, but can provide information to the GWE 112 to expose the player to certain aspects of the gambling game, such as (but not limited to) odds, amount of RC in play, and amount of RC available. The RWE 102 can accept modifications in the amount of RC wagered on each individual gambling try, or the number of gambling games per minute the RWE 102 can execute, entrance into a bonus round, and other factors, all the while these factors can take a different form than that of a typical slot machine. An example of a varying wager amount that the player can choose can include, but is not limited to, gameplay with a more powerful character, a more powerful gun, or a better car. These choices can increase or decrease the amount wagered per individual gambling game, in the same manner that a standard slot machine player can decide to wager more or less credits for each pull of the handle. In accordance with some of these embodiments, the RWE 102 can communicate a number of factors back and forth to the GWE 112, via an interface, such increase/decrease in wager being a function of the player's decision making as to their operational profile in the entertainment game (such as but not limited to the power of the character, gun selection or car choice). In this manner, the player is always in control of the per game wager amount, with the choice mapping to some parameter or component that is applicable to the entertainment game experience of the hybrid game. In accordance with a particular embodiment, the RWE 102 operation can be a game of chance as a gambling game running every 10 seconds where the amount wagered is communicated from the GWE 112 as a function of choices the player makes in the operation profile in the entertainment game.

In many embodiments, a gambling hybrid game integrates a video game style gambling machine, where the gambling game (including an RWE 102 and RC) is not player skill based, while at the same time allows players to use their skills to earn club points which a casino operator can translate to rewards, tournament opportunities and prizes for the players. The actual exchange of monetary funds earned or lost directly from gambling against a game of chance in a gambling game, such as a slot machine, is preserved. At the same time, a rich environment of rewards to stimulate gamers can be established with the entertainment game. In accordance with some of these embodiments, the gambling hybrid game can leverage very popular titles with gamers and provides a sea change environment for casinos to attract players with games that are more akin to the type of entertainment that a younger generation desires. In accordance with various embodiments, players can use their skill towards building and banking Game World Credit (GWC) that in turn can be used to win tournaments and various prizes as a function of their gamer prowess. Numerous embodiments minimize the underlying changes needed to the aforementioned entertainment software for the hybrid game to operate within an entertainment game construct, thus making a plethora of complex game titles and environments, rapid and inexpensive to deploy in a gambling environment.

In accordance with some embodiments, gambling hybrid games also allow players to gain entry into subsequent competitions through the accumulation of Game World Credits (GWC) as a function of the user's demonstrated skill at the game. These competitions can pit individual players or groups of players against one another and/or against the casino to win prizes based upon a combination of chance and skill. These competitions can be either asynchronous events, whereby players participate at a time and/or place of their choosing, or they can be synchronized events, whereby players participate at a specific time and/or venue.

In accordance with some embodiments, one or more players engage in playing an entertainment game, resident in the ESE, the outcomes of which are dependent at least in part on skill. The gambling hybrid game can include an entertainment game that includes head to head play between a single player and the computer, between two or more players against one another, or multiple players playing against the computer and/or each other, as well as the process by which players bet on the outcome of the entertainment game. The entertainment game can also be a game where the player is not playing against the computer or any other player, such as in games where the player is effectively playing against himself or herself (such as but not limited to Solitaire and Babette).

In accordance with some embodiments, the use of the RWE, GWE and ESE allows for the separation of control of a gambling hybrid game between different devices. For example, the ESE may be hosted by a device that is separate from any devices that host the RWE and/or GWE. Through separation of control of the functions of the ESE, RWE and GWE, the RWE may be isolated from the player's device, thus preventing player interference with the RWE and the gambling game. In addition, as the ESE is responsible for providing the entertainment game, gambling hybrid games may provide for complex entertainment games for the player as the ESE need not include the tightly regulated components of the RWE, thus providing for more freedom in ESE design. Also, separation of control allows a GWE to provide complex wager initiation rules that would not be possible if the either the ESE or the RWE were to be in control of the wager initiation.

In accordance with various embodiments, a gambling hybrid game allows for interleaving of continuous wagering within an entertainment game. For example, instead of wagering once, and then playing an entertainment game to completion, or playing an entertainment game to completion and then placing a wager, a gambling hybrid game allows a gaming system or device to be provided to a player where the gaming system or device provides a complex and interesting entertainment game with wagering incorporated throughout the entertainment game.

In various embodiments, a gambling hybrid game provides for feedback into the entertainment game of additional entertainment game resources that are made available in the ESE for the use of the player as the result of wagering outcomes. The additional entertainment game resources may enable portions of the entertainment game that were not available to the player without the resources.

In many embodiments, a gambling hybrid game provides the ability to use the gambling hybrid game in more than one jurisdiction, as the ESE is a component separate from the GWE and RWE. For example, the ESE may be operated as either a pure entertainment game, or as a gambling game depending on the type of characteristics of the RWE that the ESE is coupled to.

In some embodiments, a gambling hybrid game provides for display of an entertainment game on a player's device that the player is using to interact with the entertainment game, as well as providing a separate display of a state of a gambling game on a separate gambling game display. The separate gambling game display may be on the player's device within the same physical display device, on a separate device having a separate physical screen, or on a separate physical display device on the player's device.

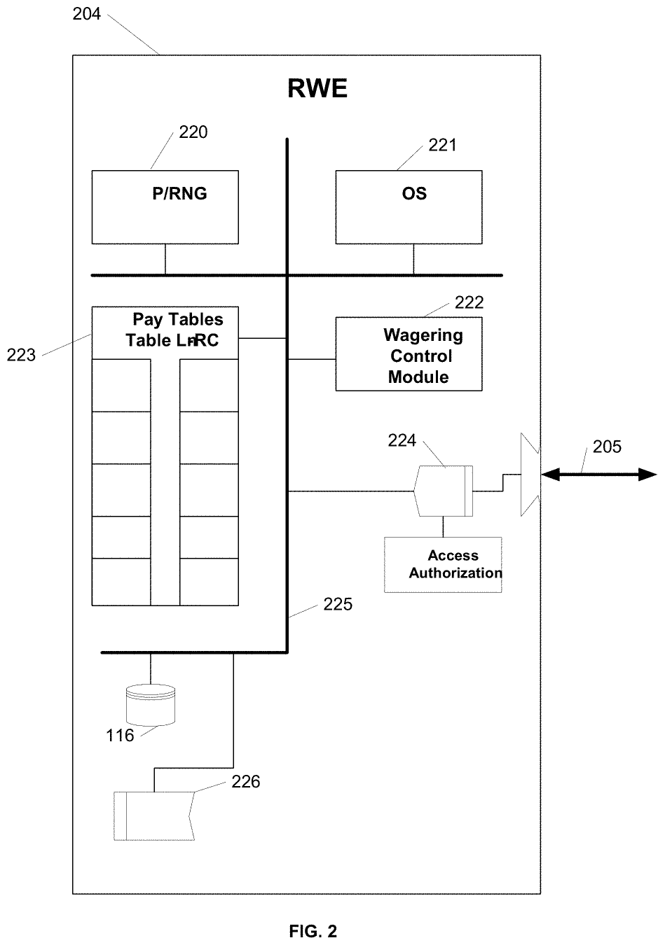

The components provided by the RWE for a gambling hybrid game in accordance with embodiments of the invention are shown in FIG. 2. In accordance with embodiments of the invention, the RWE includes an internal bus 225 that connects an operating system OS 221, a Pseudo Random or Random Number Generator (P/RNG) 220, one or more pay tables (Table Ln-RC) 223, a wagering control module 222, an authorization access module 224, and a RC credit meter 226 that are included in the RWE 204. The RW OS 221 controls the functions of the RWE 204. The P/RNG 220 includes one or more RNGs that are used to produce random numbers for use in resolving gambling events and other process requiring a random number to determine an outcome. The one or more pay tables (Table Ln-RC) 223 control the functions of the RWE and contain a plurality of factors indexed by the random number to be multiplied with the RC wagered to determine the payout on a successful wager. A wagering control module 222 performs the processes to resolve a wager on a proposition of a gambling event. The resolution process includes, but is not limited to, pulling random numbers, looking up factors in Pay Tables, multiplying the factors by the amount of RC wagered, and administering a RC credit meter 226. A repository (a credit meter) 226 maintains a record of the amount of RC which a player has deposited in the game and has been accumulated by the player.

An external connection allows the RWE 204 to interface to another system or device, which is shown in FIG. 2 as the Internet 205 but may be any other network and/or device. The authorization access module 224 of RWE 204 is connected to the external connection and provides a method to permit access and command exchange between an external system and the RWE 204. The RWE 204 also contains storage for statuses, wagers, wager outcomes, meters and other historical events in a storage device 116.

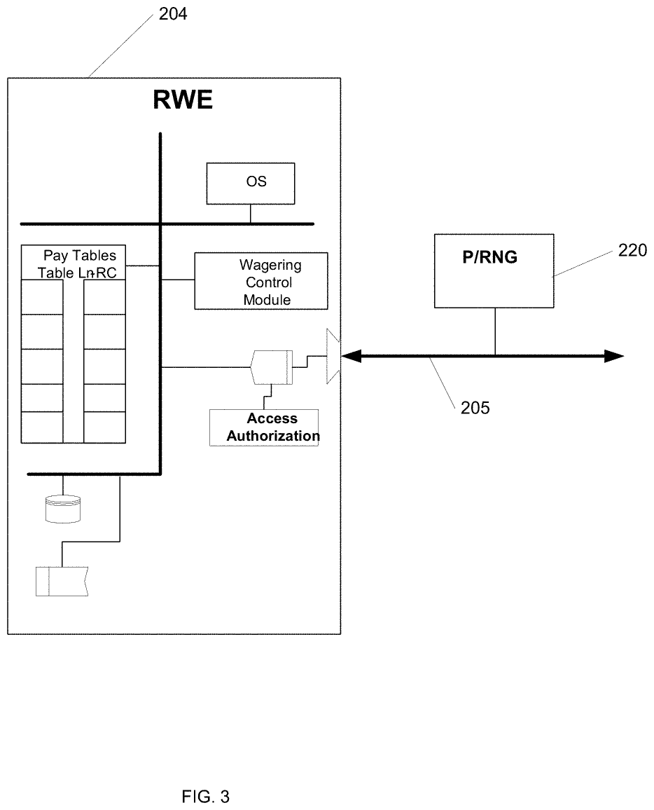

In some embodiments, the RWE 204 communicates with external systems to provide various functions of a gambling hybrid game in accordance with embodiments of the invention. The components of an RWE 204 that communicate with an external system to provide a component of the RWE 204 in accordance with embodiments of the invention are shown in FIG. 3. The RWE 204 shown in FIG.3 is similar to the RWE shown in FIG. 2. However, the P/RNG 220 is an external system connected to the RWE 204 by the Internet 205 in accordance with embodiments of the invention. The P/RNG 220 could be a central deterministic system, such as a regulated and controlled random numbered ball selection device, or some other system which provides random or pseudo random numbers to one or a plurality of connected RWEs 204. One skilled in the art will recognize that only P/RNG 220 is an external system in the embodiment illustrated in FIG. 3. However, any of the components could be external systems without departing from the invention and P/RNG 220 is shown as an example only.

In FIGS. 2 and 3, the RWE 204 interfaces with other systems/devices or to an external P/RNG 220 using the Internet 205. However, one skilled in the art will note that nothing would preclude using a different interface than the Internet 205 in other embodiments of the invention. Other examples of interfaces include, but are not limited to, a LAN, a USB interface, or some other method by which two electronic and software constructs could communicate with each other.

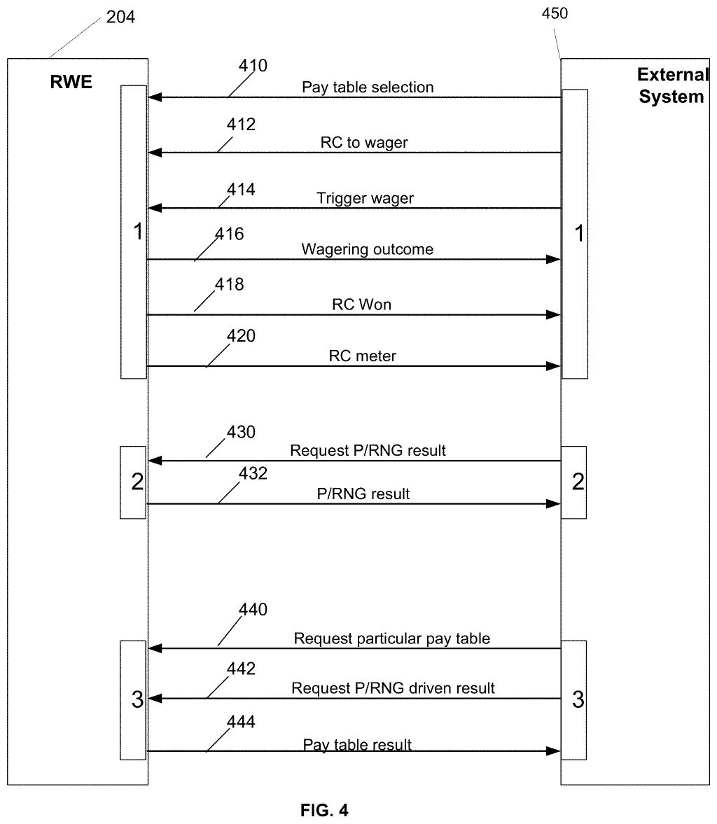

The RWE and an external system typically communicate to provide the resolution of gambling events to resolve wagers on the events. The signals between the RWE and an external system to provide some process related to resolving gambling events in accordance with embodiments of the invention are shown in FIG. 4. In accordance with many embodiments of the invention, the primary function of the RWE 204 is to manage wagering events and to provide random (or pseudo random) numbers from an RNG. At the top of the figure, a 6 component communication exchange grouped by the “1” box is shown for a wager on a proposition in a gambling event during a gambling hybrid game in accordance with embodiments of the invention. An external system 450 that is requesting wagering support from the RWE 204 instructs the RWE 204 as to the pay table (Table Ln-RC) to use (410), followed by the amount of RC to wager on the proposition of the gambling event (412). Next, the external system 450 signals the RWE to trigger a wager or perform the gambling event (414). The RWE 204 resolves the gambling event. The RWE 204 then informs external system 450 as to the outcome of the wager (416), the amount of RC won (418), and the amount of RC in the player's account (in the credit repository) (420).

A second communication exchange between the RWE 204 and an external system 450 in accordance with embodiments of the invention that is shown in FIG. 4 is grouped by the “2” box in FIG. 4 and relates to the external system 450 needing an P/RNG result support from the RWE 204. In this exchange, the external system 450 requests an P/RNG result from the RWE 204 (430). The RWE 204 returns a P/RNG result to the external system 450 in response to the request (432). The result may be generated as a function of the internal P/RNG in the RWE 204, or from a P/RNG external to the RWE 204 to which the RWE 204 is connected.

A third communication exchange between the RWE 204 and the external system 450 in accordance with embodiments of the invention that is shown in FIG. 4 is grouped by the “3” box in the figure and relates to the external system 450 wanting support on coupling an P/RNG result to a particular Pay Table contained in the RWE 204. In this exchange, the external system 450 instructs the RWE as to the pay table (Table Ln-RC) to use (440). The external system (450) then requests a result whereby the P/RNG result is coupled to the requested Pay Table (442). The result is returned to the external system 450 by RWE 204 (444). Such an aspect is different from the first exchange shown by the box “1” sequence in that no actual RC wager is conducted. However, such a process, t, might be useful in coupling certain non-RC wagering entertainment game behaviors and propositions to the same final resultant wagering return which is understood for the gambling hybrid game to conduct wagering.

In regards to FIG. 4, one skilled in the art will note that the thrust of the FIG. 4 is to convey overall functional exchanges between an RWE 204 and an external system 450. As such, various protocol layers necessary for error free and secure communication, and other status, setup, and configuration commands which one might expect in any protocol between two connected systems have been omitted for clarity. Furthermore, some or all of the various commands and responses illustrated could be combined into one or more communication packets without departing from the invention.

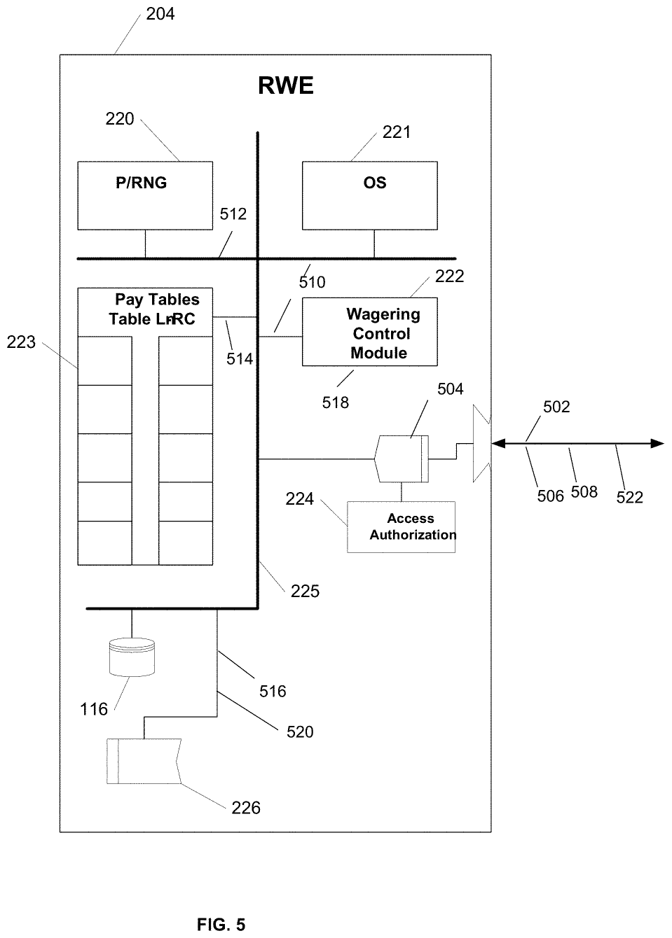

The process flow for functional communication exchanges, such as communication exchanges described above with reference to FIG. 4, between a RWE and an external system in accordance with embodiments of the invention are shown in FIG. 5. The process begins by a RWE 204 receiving signals from an external system requesting a connection to RWE 204 (502). The Access Authorization Module determines that the external system is authorized to connect to RWE 204 (504) and transmits an authorization response to the external system. The external systems provide a request for a gambling event to be performed to the RWE 294 (506). The request may include an indication of a wager amount on a proposition in the gambling event, and a proper pay table to use to resolve the wager. The external system then sends a signal to trigger the gambling event (508).

The OS 221 instructs the Wager Control Module 222 as to the RC wager and the Pay Table to select as well as to resolve the wager execution (510). In response to the request to execute the gambling event, the wager control module 222 requests an P/RNG result from the P/RNG 220 (512); retrieves a proper pay table or tables from the pay tables 223 (514); adjusts the RC of the player in the RC repository 226 as instructed (516); applies the P/RNG result to the particular pay table or tables (518); and multiplies the resultant factor from the Pay Table by the amount of RC to determine the result of the wager (518). Wager Control Module 222 then adds the amount of RC won by the wager to the RC repository 226 (520); and provides he outcome of the wager, and the amount of RC in the RWE and the RC won (522). One skilled in the art will recognize that there may be many embodiments of an RWE 204 which could be possible, including forms where many modules and components of the RWE are located in various servers and locations, so the foregoing is not meant to be exhaustive or all inclusive, but rather provide information about an RWE 204 in accordance with some embodiments of the invention.

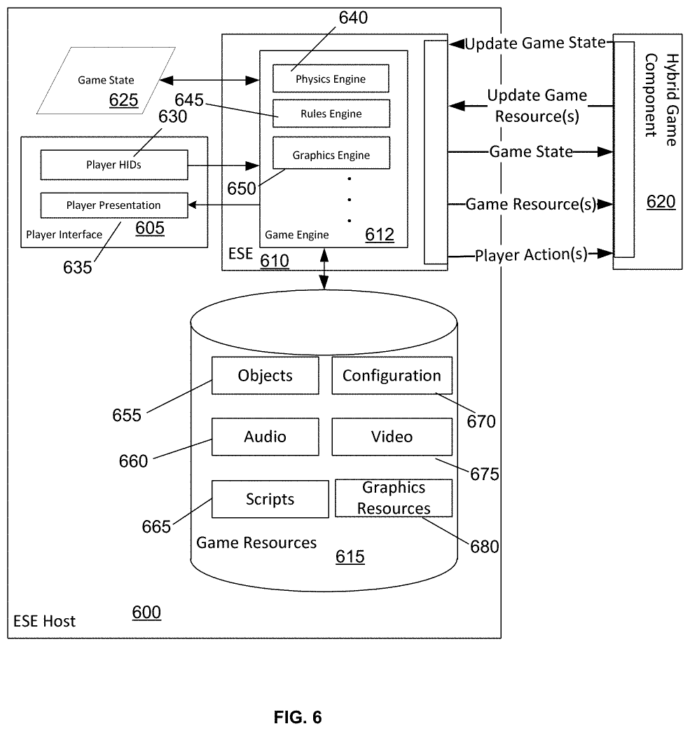

A block diagram of components of an ESE being provided by an ESE host 600 for a gambling hybrid game in accordance with embodiments of the invention is shown in FIG. 6. An ESE 610 may be part of the entertainment game itself, may be a software module that is executed by the entertainment game, or may provide an execution environment for the entertainment game for a particular host. The ESE 610 and associated entertainment game are hosted by an ESE host 600. The ESE host 600 is a computing device that is capable of hosting the ESE 610 and the entertainment game. Exemplary hosts include video game consoles, smart phones, personal computers, tablet computers, or the like. The entertainment game includes a game engine 612 that generates a player interface 605 for interaction with by a player. The player interface includes a player presentation 635 that is presented to a player through the player interface. The player presentation 635 may be audio, visual or tactile, or any combination of such. The player interface 635 further includes one or more Human Input Devices (HIDs) 630 that the player uses to interact with the entertainment game. Various components or sub-engines of the game engine read data from a game state in order to implement the features of the game. Components of the game engine include a physics engine 640 used to simulate physical interactions between virtual objects in the game state, a rules engine 645 for implementing the rules of the game, an P/RNG that may be used for influencing or determining certain variables and/or outcomes to provide a randomizing influence on gameplay, a graphics engine 650 used to generate a visual representation of the game state to the player, an audio engine to generate audio outputs for the player interface, and any other engine needed to provide the entertainment game. The game engine 612 reads and writes game resources 615 stored on a data store of the ESE host. The game resources 615 include game objects 655 having graphics and/or control logic used to implement game world objects of the game engine. The game resources 615 also include video files 675 that are used to generate cut-scenes for the entertainment game. The game resources 615 may also include audio files 660 used to generate music, sound effects, etc. within the entertainment game. The game resources 615 may also include configuration files 670 used to configure the features of the entertainment game. The game resources 615 may also include scripts 665 or other types of control code used to implement various gameplay features of the entertainment game. The game resources 615 may also include graphics resources 680 including, but not limited to, textures, and objects that are used by the game engine to render objects displayed in the entertainment game.

In operation, components of the game engine 612 read portions of the game state 625 and generate the player presentation for the player which is presented to the player using the player interface 605. The player perceives the presentation 635 and provides player inputs using the HIDs 630. The corresponding player inputs are received as player actions or inputs by various components of the game engine 612. The game engine translates the player actions into interactions with the virtual objects of the game world stored in the game state 625. Components of the game engine 612 use the player interactions with the virtual objects of the game and the game state 625 to update the game state 625 and update the presentation 635 presented to the user. The process can loop in a game loop continuously while the player plays the game.

In some embodiments, the ESE 610 is a host running a browser that communicates with a server serving documents in a markup language, such as Hypertext Markup Language 5 (HTML 5) or the like, and the functions of the game engine are performed by the browser on the basis of the markup language found in the documents. In some embodiments, the ESE 610 is a host hosting a specialized software platform, such as Adobe Flash or the like, used to implement games or other types of multimedia presentations, and the functions of the game engine are performed by the specialized platform.

The ESE 610 provides one or more interfaces between an entertainment game and other components 620 of a gambling hybrid game, such as a GWE. The ESE 610 and the other gambling hybrid game component 620 communicate with each other using the interfaces, such as by passing various types of data and sending and receiving messages, status information, commands and the like. Examples of communications include, but are not limited to, requesting by the gambling hybrid game component 620 that the ESE 610 update the game state using information provided by the other component; requesting, by the gambling hybrid game component 620, that the ESE 610 update one or more game resources using information provided by the gambling hybrid game component 620; the ESE 610 providing all or a portion of the game state; the ESE 610 providing one or more of the game resources to the gambling hybrid game component 620; and the ESE 610 communicating player actions to the other gambling hybrid game component 620. The player actions may be low level player interactions with the player interface, such as manipulation of an HID, or may be high level interactions with objects as determined by the entertainment game. The player actions may also include resultant actions such as modifications to the game state or game resources resulting from the player's actions taken in the game. Other examples of player actions include actions taken by entities, such as Non-Player Characters (NPC) of the entertainment game, that act on behalf of, or under the control of, the player.

Elements are a limited resource consumed within an entertainment game to advance entertainment game gameplay. In playing the entertainment game using the elements, a player can (optionally) consume and accrue game world credits (GWC) within the entertainment game. These credits can be in the form of (but are not limited to) game world credits, experience points, or points generally. Wagers can be made in the gambling game as triggered by the player's use of one or more elements of the entertainment game. The wagers are made using real world credits (RC). The real world credits can be credits in an actual currency, or can be credits in a virtual currency which may have a real world value. Gambling results from the gambling game can cause consumption, loss or accrual of RC. In addition, gambling results in the gambling game can influence elements in the entertainment game such as (but not limited to) by restoring a consumed element, causing the loss of an element, restoration or placement of a fixed element. In certain embodiments, gambling games can facilitate the wager of GWC for a randomly generated payout of GWC or a wager of elements for a randomly generated payout of elements. In particular embodiments, an amount of GWC and/or elements used as part of a wager can have a RC value if cashed out of a gameplay session.

Example elements include enabling elements (EE) which are elements that enable a player's play of the entertainment game and whose consumption by the player while playing the entertainment game can trigger a wager in a gambling game. Another non limiting example of an element is a reserve enabling element (REE), which is an element that converts into one or more enabling elements upon occurrence of a release event in skill wagering interleaved game gameplay. Other types of elements include actionable elements (AE) which are elements that are acted upon to trigger a wager in the gambling game and may or may not be restorable during normal play of the entertainment game. Another type of element is a common enabling element (CEE) which as an element that may be shared by two or more players and the use of which by any of the players causes a wager to be triggered.

In progressing through entertainment game gameplay, elements can be utilized by a player during interactions with a controlled entity (CE) which is a character, entity, inanimate object, device or other object under control of a player.

Also, entertainment game gameplay progress and wager triggers can be dependent upon a game world variable such as, but not limited to: a required game object (RGO) which is a specific game object in an entertainment game acted upon for an AE to be completed (such as but not limited to a specific key needed to open a door); a required environmental condition (REC) which is a game state present within an entertainment game for an AE to be completed (such as but not limited to daylight whose presence enables a character to walk through woods); or a controlled entity characteristic (CEC) which is a status of the CE within an entertainment game for an AE to be completed (such as but not limited to a CE to have full health points before entering battle). Although various gameplay resources, such as but not limited to GWC, RC and elements as discussed above, any gameplay resource can be utilized to advance gameplay as well as form the basis for a trigger of a wager as appropriate to the specification of a specific application in accordance with various embodiments of the invention. Various hybrid games are discussed in PCT Application Nos. PCT/US11/26768, filed Mar. 1, 2011, PCT/US11/63587, filed Dec. 6, 2011, and PCT/US12/50204 filed Aug. 9, 2012, each disclosure of which is hereby incorporated by reference in its entirety.

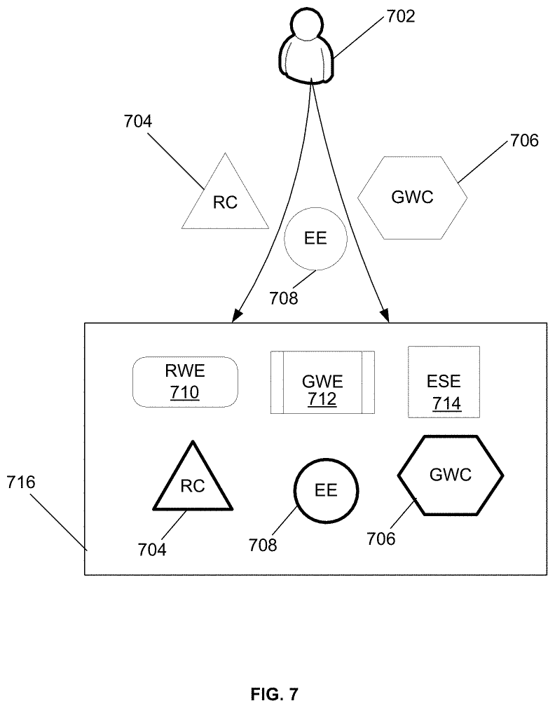

In accordance with some embodiments, a player can interact with a gambling hybrid game by using RC in interactions with a gambling game along with GWC and elements in interactions with an entertainment game. The gambling game can be executed by a RWE while an entertainment game can be executed with an ESE and managed with a GWE. A conceptual diagram that illustrates how resources such as GWC, RC and elements, such as but not limited to enabling elements (EE), are utilized in a gambling hybrid game in accordance with an embodiment of the invention is illustrated in FIG. 7. The conceptual diagram illustrates that RC 704, EE 708 and GWC 706 can be utilized by a player 702 in interactions with the RWE 710, GWE 712 and ESE 714 of a gambling hybrid game 716. The contribution of elements, such as EE 708, can be linked to a player's access to credits, such as RC 704 or GWC 706. Electronic receipt of these credits can come via a smart card, voucher or other portable media, or as received over a network from a server. In accordance with certain embodiments, these credits can be drawn on demand from a player profile located in a database locally on a gambling hybrid game or in a remote server.

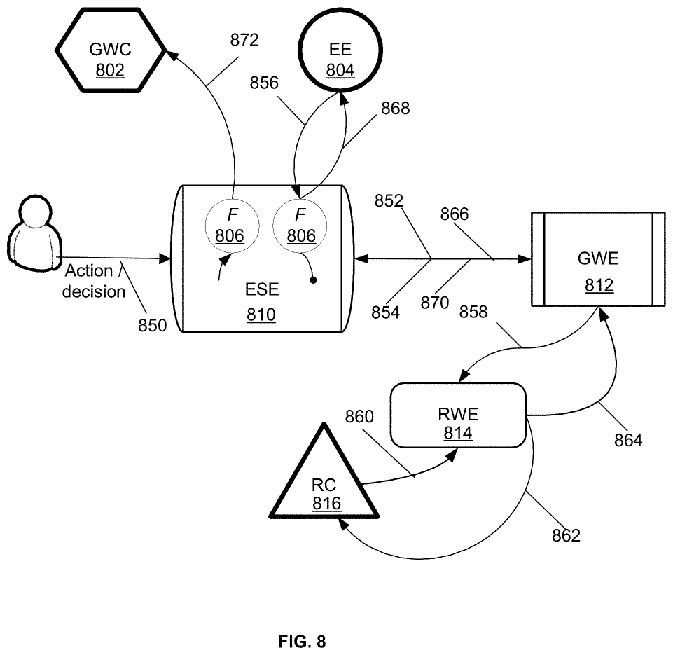

A conceptual diagram that illustrates the interplay between aspects of a gambling hybrid game in accordance with an embodiment of the invention using real world credit (RC) is illustrated in FIG. 8. Similar to FIG. 7, a player's actions and/or decisions can affect functions 806 that consume and/or accumulate GWC 802 and/or EE 804 in an entertainment game executed by an ESE 810. A GWE 812 can monitor the activities taking place within an entertainment game executed by an ESE 810 for gameplay gambling event occurrences. The GWE 812 can also communicate the gameplay gambling event occurrences to an RWE 814 that triggers a wager of RC 816 in a gambling game executed by the RWE 814.

In accordance with some embodiments of the invention, the following may occur during use of the gambling hybrid game. The user enters an input that represents an action or decision (850). The ESE 810 signals the GWE 812 with the input decision or action (852). The GWE 812 responds by signaling to ESE 810 with the amount of EE that is consumed by the player action or decision (854). The signaling from the GWE 812 configures a function 806 to control the EE consumption, decay, and/or accumulation.

The ESE 810 then adjusts the EE 804 accordingly (856). The GWE 812 signals the RWE 814 as to the profile of the wager proposition associated with the action or decision and triggers the wager (858). The RWE 814 consumes the appropriate amount of RC 816 and executes the wager (860). The RWE 814 then adjusts the RC 816 based upon the outcome of the wager (862) and informs the GWE 812 as to the outcome of the wager (864).

The GWE 812 signals the ESE 810 to adjust EE to one or more of the EEs of the ESE entertainment game (866). Function 806 of the ESE 810 performs the adjustment of EE 804 (868). The ESE 810 signals the GWE 812 as to the updated status (870). In response, the GWE 812 signals the ESE 810 to update GWC of the entertainment game. The ESE updates the GWC 802 using a function 806 (872).

The following is an example of the above flow in a first person shooter game, such a Call of Duty®, using a gambling hybrid game sequence in accordance with embodiments of the invention.

The process begins by a player selecting a machine gun to use in the game and then fires a burst of bullets at an opponent (850). The ESE 810 signals the GWE 812 of the player's choice of weapon, that a burst of bullets was fired, and the outcome of the burst (852). GWE 812 processes the information received and signals ESE 810 to consume 3 bullets (EE) with each pull of the trigger (854). The ESE 810 consumes 3 bullets for the burst using function 806 (856).

The GWE 812 signals the RWE 814 that 3 credits (RC) are to be wagered to match the three bullets consumed. The RWE 814 then determines the result of the wager and may determine the winnings from a pay table. On a particular pay table (Table Ln-RC), a determination is made by RWE 814 as to the amount of damage that the opponent has sustained. The RWE 814 consumes 3 credits of RC 816 for the wager and executes the specified wager (860). The RWE 814 determines that the player hit a jackpot of 6 credits and returns the 6 credits to the RC 816 (862) and signals the GWE 812 that 3 net credits were won by the player (864).

The GWE 812 signals ESE 810 to add 3 bullets to an ammunition clip (866). ESE 810 adds 3 bullets back to the ammo clip (EE 804) using a function 806 (868). The ammunition may be added by directly adding the ammunition to the clip or by allowing the user to find extra ammunition during gameplay. The GWE 812 logs the new player score (GWC 802) in the game (as a function of the successful hit on the opponent) based on the ESE 810 signaling, and the signals the ESE 810 to add 2 extra points to the player score since a jackpot has been won (870). The ESE 810 then adds 10 points to the player score (GWC 802) given the success of the hit which in this example is worth 8 points, plus the 2 extra points requested by GWE 812 (872). Note that the foregoing example is only intended to provide an illustration of how credits flow in a gambling hybrid game, but is not intended to be exhaustive and only lists only one of numerous possibilities of how a gambling hybrid game may be configured to manage its fundamental credits.

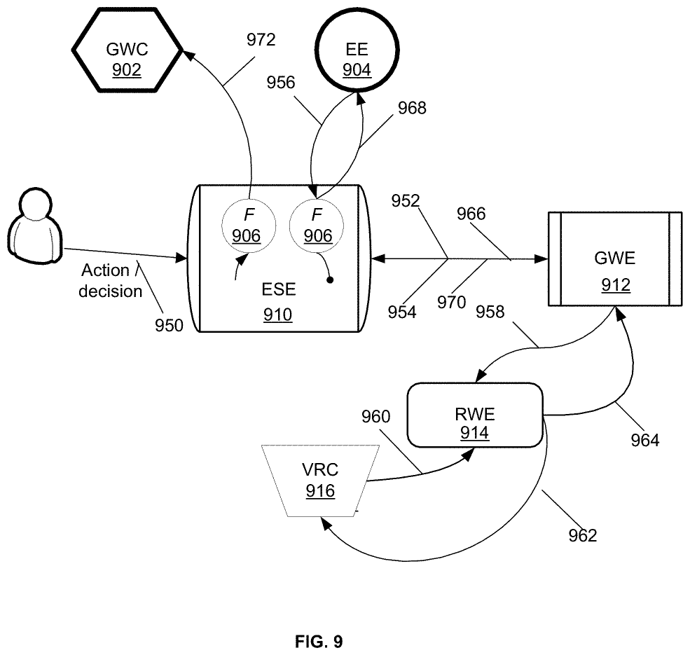

A conceptual diagram that illustrates the interplay between aspects of a gambling hybrid game in accordance with an embodiment of the invention using virtual real world credit (VRC) is illustrated in FIG. 9. As seen in the FIG. 9, substituting VRC in place of RC is effected without impact to the architecture or operation of the gambling hybrid game. The implementation of FIG. 9 is not the only embodiment using virtual currency within a gambling hybrid game, but shows only one permutation of which many could exist.

Similar to FIG. 8, a player's actions and/or decisions can affect functions 906 that consume and/or accumulate GWC 902 and/or EE 904 in an entertainment game executed by an ESE 910 in the process shown in FIG. 9. A GWE 912 can monitor the activities taking place within an entertainment game executed by an ESE 910 for gameplay gambling event occurrences. The GWE 912 can also communicate the gameplay gambling event occurrences to a RWE 914. Unlike the process shown in FIG. 8, RWE 914 triggers a wager of virtual real world credit (VRC) 916 in a gambling game executed by the RWE 914.

For purposes of this discussion, VRC can be thought of as a form of alternate currency, which can be acquired, purchased or transferred, in unit or in bulk, by/to a player, but does not necessarily directly correlate to RC or real currency. As an example, there is a virtual currency called “Triax Jacks”, 1000 units of which are given to a player by an operator of a gambling hybrid game, with additional blocks of 1000 units being available for purchase for $5 USD each block. Triax Jacks could be redeemed for various prizes, or could never be redeemed but simply used and traded purely for entertainment value by players. It would be completely consistent with the architecture of the gambling hybrid game that Triax Jacks would be wagered in place of RC, such that the gambling hybrid game could be played for free, or with played with operator sponsored Triax Jacks.

Returning to the process in FIG. 9, the following may occur during use of the gambling hybrid game in accordance with embodiments of the invention. The user enters an input that represents an action or decision (950). The ESE 910 signals the GWE 912 with the input decision or action (952). The GWE 912 responds by signaling to ESE 910 with the amount of EE that is consumed by the player action or decision (954). The signaling from the GWE 912 configures a function 906 to control the EE consumption, decay, and/or accumulation.

The ESE 910 then adjusts the EE 904 accordingly (956). The GWE 912 signals the RWE 914 as to the profile of the wager proposition associated with the action or decision and triggers the wager (958). The RWE 914 consumes the appropriate amount of RC 916 and executes the wager (960). The RWE 914 then adjusts the RC 916 based upon the outcome of the wager (962) and informs the GWE 912 as to the outcome of the wager (964).

The GWE 912 signals the ESE 910 to adjust EE to one or more of the EEs of the ESE entertainment game (966). Function 906 of the ESE 910 performs the adjustment of EE 904 (968). The ESE 910 signals the GWE 912 as to the updated status (970). In response, the GWE 912 signals the ESE 910 to update GWC 902 of the entertainment game. The ESE updates the GWC 902 using a function 906 (972).

Network Based Gambling Hybrid Game

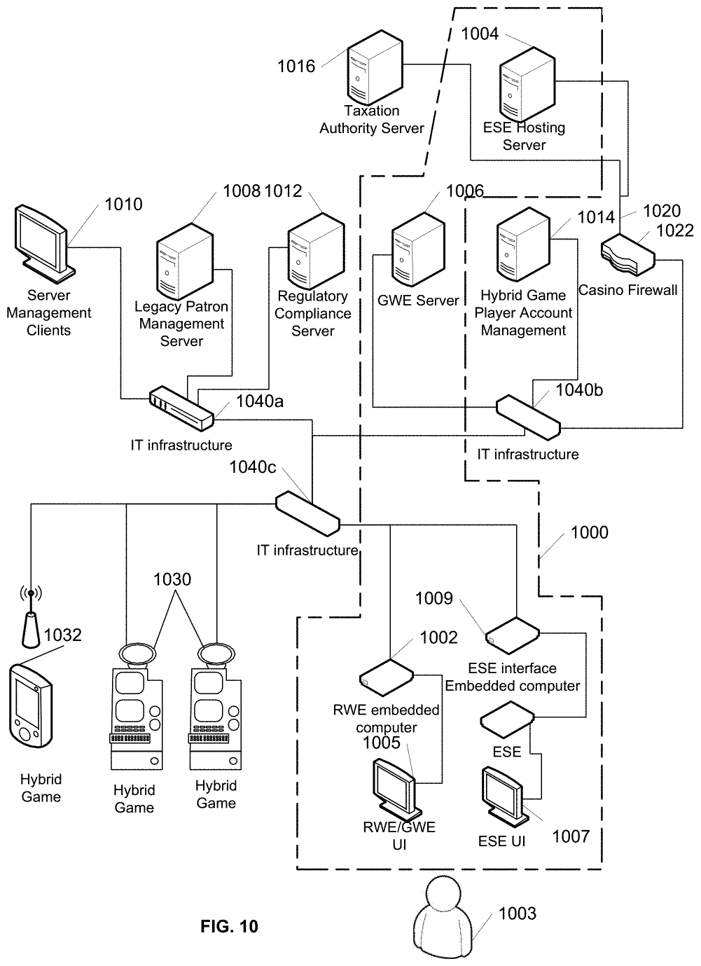

A system diagram that illustrates an implementation of a network distributed gambling hybrid game with a GWE local server in accordance with embodiments of the invention is illustrated in FIG. 10. In the figure, the gambling hybrid game 1000 includes components, RWE 1002 embedded in a device used as the user interface for player 1003. The device provides both a RWE/GWE user interface 1005 and an ESE user interface 1007 for the player. The ESE is provisioned by an ESE hosting server 1004 via ESE interface 1009, and the GWE is provisioned by GWE server 1006 as indicated by the dashed line. Also pictured in the diagram are a number of other peripheral systems, such as player management 1008, casino management 1010, regulatory 1012, hybrid game player account management 1014, and taxation authority 1016 hosting servers that may be present in such an implementation. FIG. 10 also illustrates various other systems, which may reside outside the bounds of the casino and are connected to the framework via communications network, such as the Internet 1020, depicted by the connection lines past the casino firewall 1022. The end devices utilized for user interfaces for a gambling hybrid game include, but are not limited to, casino electronic game machines 1030 and wireless or portable devices, such as smart phone 1032, personal digital assistants, tablet computers, video gaming consoles or the like. These disparate devices are connected within and without the casino through the casino's information technology structure as illustrated by routers 1040a, 1040b and 1040c. It should be understood that FIG. 10 does not attempt to illustrate all servers and systems to which a gambling hybrid game 1000 might be inevitably be connected, and indeed one might expect there would be others, but rather provides an example of a set of a sub-set of systems which would be present in an exemplary embodiment of an installation.

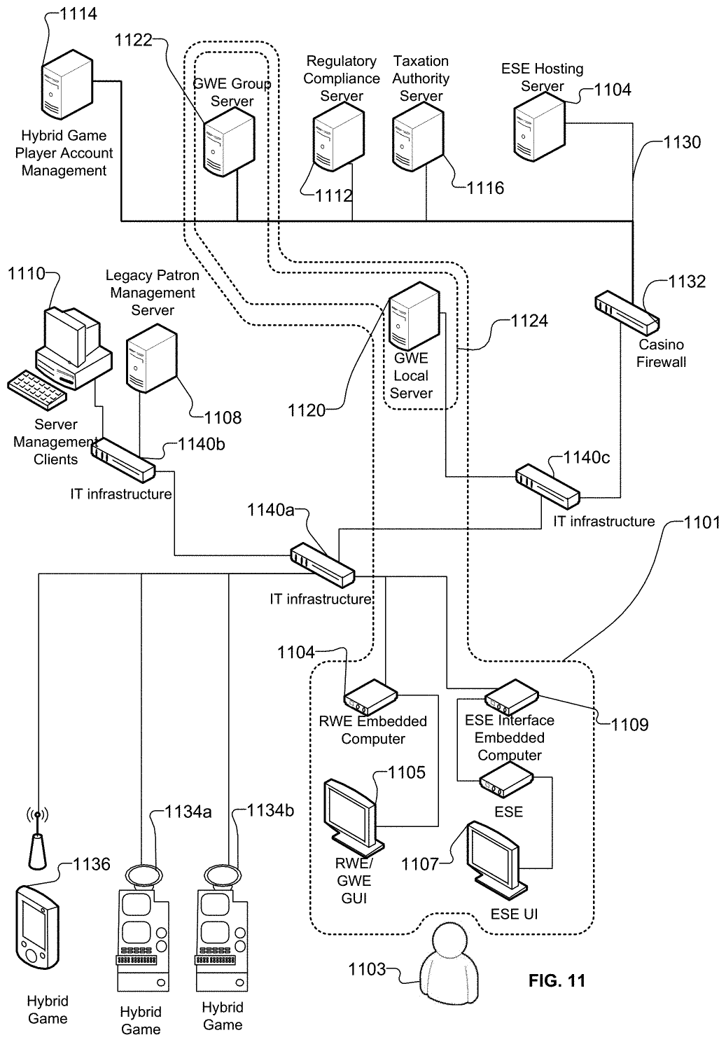

FIG. 11 is a diagram showing another implementation of a gambling hybrid game in accordance with an exemplary embodiment. In the figure, the gambling hybrid game 1101 includes components, RWE 1104 embedded in a device used as the user interface for player 1103. The device provides both a RWE/GWE user interface 1105 and an ESE user interface 1007 for the player. The ESE is provisioned by an ESE hosting server 1104 via ESE interface 1109. Also pictured in the diagram are a number of other peripheral systems, such as player management 1108, casino management 1110, regulatory 1112, hybrid game player account management 1114, and taxation authority 1116 hosting servers that may be present in such an implementation. In the figure, note that the GWE is composed of two sub-components, a local GWE server 1120, and a cloud server 1122 (components within the dash line area 1124). In the figure, certain of the components are located within the bounds of the casino, namely the RWE, the ESE and a portion of the GWE, namely the local GWE server 1120. The Cloud Server GWE 1122 is located in the cloud connected to the casino bounded gambling hybrid game components via communications network such as the Internet 1130 through a firewall 1132. FIG. 11 also illustrates various other systems, which may reside outside the bounds of the casino and are connected to the framework via communications network. The end devices utilized for user interfaces for a gambling hybrid game include, but are not limited to, casino electronic game machines, 1134a and 1134b, and wireless or portable devices, such as smart phone 1136, personal digital assistants, tablet computers, video gaming consoles or the like. These disparate devices are connected within and without the casino through the casino's information technology structure as illustrated by routers 1140a, 1140b and 1140c. It should be understood that FIG. 11 does not attempt to illustrate all servers and systems to which a gambling hybrid game might be inevitably be connected, and indeed one might expect there would be others, but rather provides an example of a set of a sub-set of systems which would be present in an exemplary embodiment of an installation.

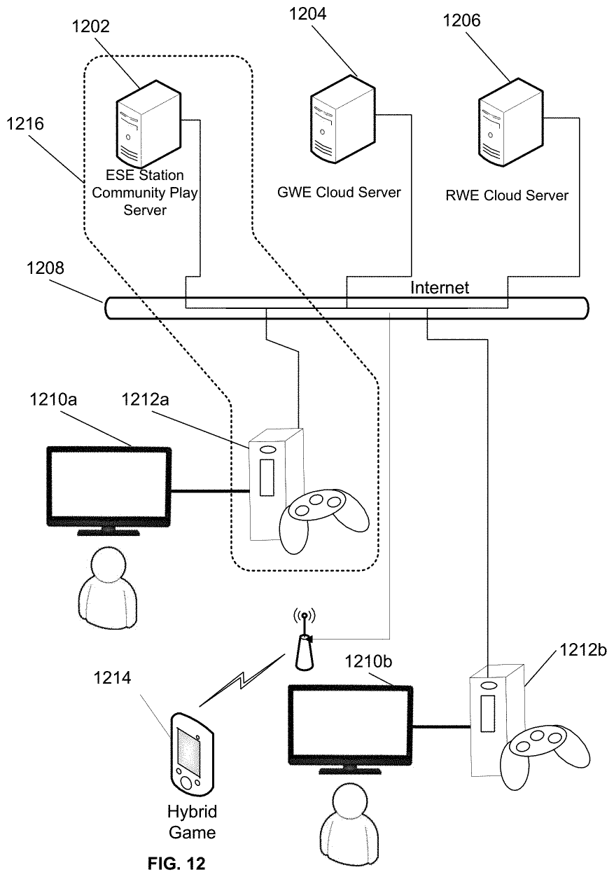

A system diagram that illustrates an implementation of network a cloud based gambling hybrid game over the Internet in accordance with an embodiment of the invention is illustrated in FIG. 12. The system includes an ESE server 1202, GWE server 1204 and RWE server 1206 that each connect to a user interface, 1210a or 1210b, (such as, but not limited to, a television screen, computer terminal, tablet, touchscreen or PDA) of gambling hybrid games over the Internet 1208. Each gambling hybrid game includes a local ESE 1212a or 1212b (such as, but not limited to, a video game console or a gaming computer system) that interfaces with a remote ESE server 1002. Processes performed by an ESE 1212a services can be performed in multiple locations, such as, but not limited to, remotely on an ESE server 1202 and locally on a local ESE 1212a. In addition, a gambling hybrid game may include a Personal Digital Assistant (PDA) 1214 or other type of mobile computing device game coupled to the ESE hosting server 1202, thus providing the opportunity for a player to play a gambling hybrid game on the PDA through a mobile phone or data network.

There are many possible permutations of how a gambling hybrid game could be constructed, with FIGS. 10, 11 and 12 showing only three possible permutations and provided as examples, which are not intended to suggest limitations to the forms of the architecture. Other embodiments include a version where the entire gambling hybrid game is in the cloud with only a client running on player terminal within the bounds of the casino, or a version where the RWE and GWE are casino bound and the ESE exists in the cloud, accessed by a client running on a terminal in the casino.

Processing Apparatuses

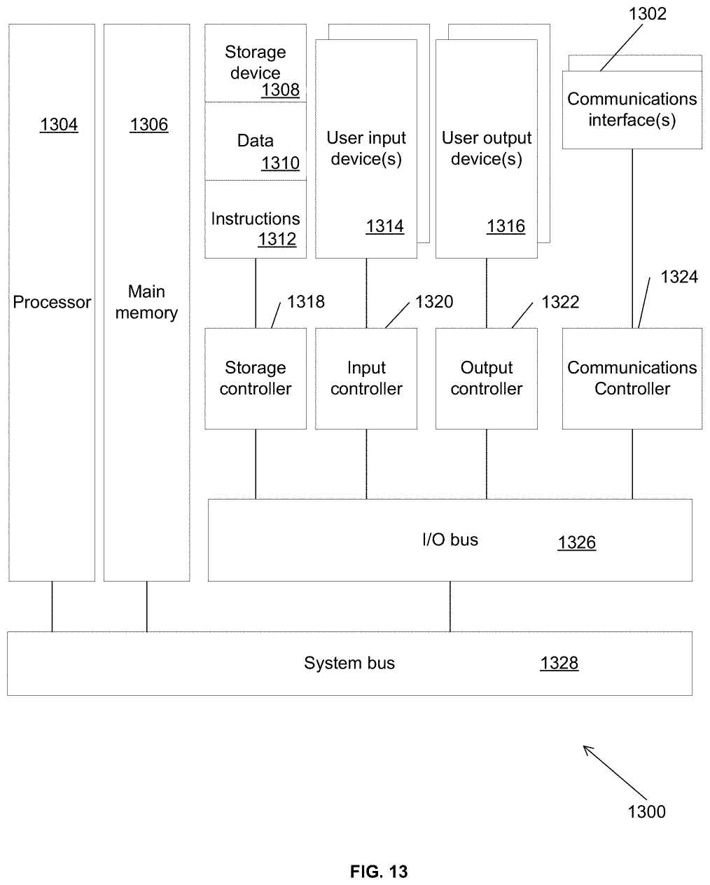

Any of a variety of processing apparatuses can host various components of a gambling hybrid game in accordance with embodiments of the invention. In accordance with embodiments of the invention, these processing apparatuses can include, but are not limited to, a server, a client, a mobile device such as a smartphone, a personal digital assistant or the like, a wireless device such as a tablet computer or the like, an electronic gaming machine, a general purpose computer, a gaming console, a computing device and/or a controller. A processing apparatus that is constructed to implement a gambling hybrid game in accordance with embodiments of the invention is illustrated in FIG. 13. In the processing apparatus 1300, a processor 1304 is coupled to memory 1306 by a bus 1328. The processor 1304 is also coupled to non-transitory machine-readable storage media, such as a storage device 1308 that stores executable instructions 1312 and data 1310 through the system bus 1328 to an I/O bus 1326 through a storage controller 1318. The processor 1304 is also coupled to one or more interfaces that can be used to connect the processor to other processing apparatuses as well as networks as described herein. The processor 1304 is also coupled via the bus to user input devices 1314, such as tactile devices including, but not limited to, keyboards, keypads, foot pads, touch screens, and/or trackballs; as well as non-contact devices such as audio input devices, motion sensors and motion capture devices that the processing apparatus can use to receive inputs from a user when the user interacts with the processing apparatus. The processor 1304 is connected to these user input devices 1314 through the system bus 1328, to the I/O bus 1326 and through the input controller 1320. The processor 1304 is also coupled via the bus to user output devices 1316 such as (but not limited to) visual output devices, audio output devices, and/or tactile output devices that the processing apparatus uses to generate outputs perceivable by the user when the user interacts with the processing apparatus. In accordance with some embodiments, the processor is coupled to visual output devices such as (but not limited to) display screens, light panels, and/or lighted displays. In accordance with particular embodiments, the processor is coupled to audio output devices such as (but not limited to) speakers, and/or sound amplifiers. In accordance with many of these embodiments, the processor 1304 is coupled to tactile output devices like vibrators, and/or manipulators. The processor 1304 is connected to output devices from the system bus 1328 to the I/O bus 1326 and through the output controller 1322. The processor 1304 can also be connected to a communications interface 1302 from the system bus 1328 to the I/O bus 1326 through a communications controller 1324.

In accordance with various embodiments, a processor 1304 can load instructions and data from the storage device into the memory 1306. The processor 1304 can also execute instructions that operate on the data to implement various aspects and features of the components of a gambling hybrid game. The processor 1304 can utilize various input and output devices in accordance with the instructions and the data in order to create and operate user interfaces for players or operators of a gambling hybrid game(such as but not limited to a casino that hosts the gambling hybrid game).

Although the processing apparatus 1300 is described herein as being constructed from a processor and instructions stored and executed by hardware components, the processing apparatus can be composed of only hardware components in accordance with other embodiments. In addition, although the storage device is described as being coupled to the processor through a bus, those skilled in the art of processing apparatuses will understand that the storage device can include removable media such as, but not limited to, a USB memory device, an optical CD ROM, magnetic media such as tape and disks. Also, the storage device can be accessed by processor 1304 through one of the interfaces or over a network. Furthermore, any of the user input devices or user output devices can be coupled to the processor 1304 via one of the interfaces or over a network. In addition, although a single processor 1304 is described, those skilled in the art will understand that the processor 1304 can be a controller or other computing device or a separate computer as well as be composed of multiple processors or computing devices including one or more processors.

### Gambling Hybrid Games Including Gambling Integrated Games

In accordance with many embodiments of the invention, a gambling hybrid game provides an entertainment game and a gambling game. A wide array of entertainment games include explicit random events that are observable to the game's player(s) and often initiated by a player. Random events can include, but are not limited to, the drawing of cards, the rolling of a die, and the use of a spinner. These explicit random events can be singular or multiple, operating in parallel or in serial. For example, Monopoly® provided by Hasbro Inc. of Pawtucket, R.I. is played by each player rolling a pair of dice at the onset of each turn to move a game piece around the board (singular per turn, and serially between players). In Risk® provided by Hasbro Inc. of Pawtucket, R.I., two players roll dice simultaneously to establish the outcome of a battle, and the players continue to roll dice until the battle is resolved (parallel dice rolls occurring multiple times). In Scrabble® provided by Hasbro Inc. of Pawtucket, R.I., a player draws tiles at random from a pool of tiles. In War, players draw randomly ordered cards from a deck of cards and compare those cards each turn. These random events are typically initiated by a player as part of a player's turn and can drive actions such as the movement of a player piece around a board (e.g. Monopoly®), the resolution of a battle between players (e.g. Risk®), establishing whether a character successfully deploys a specific skill (e.g. Dungeons and Dragons®), etc. Although the above examples discussed are board games, the same principle can be applied in computerized versions of these games.

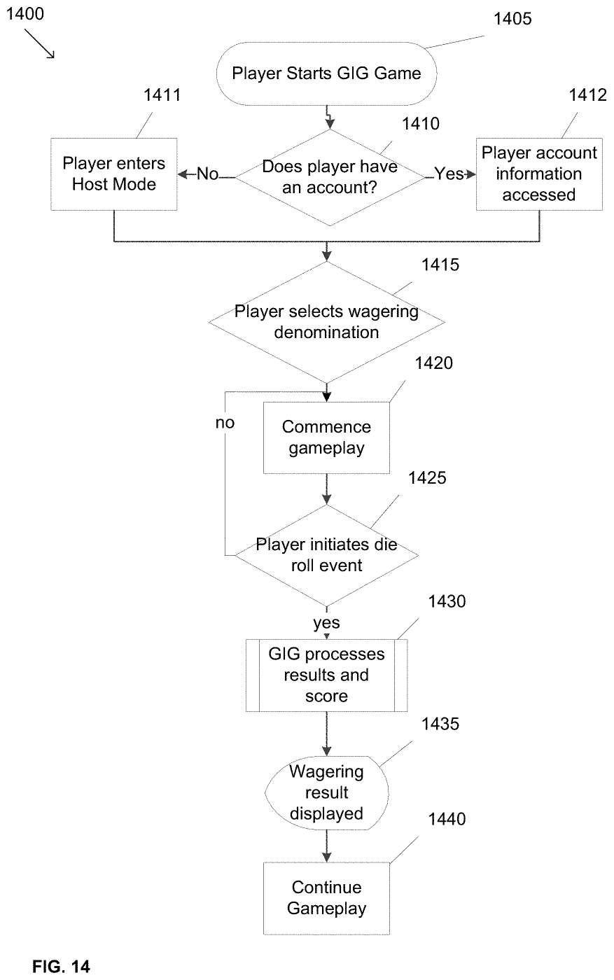

In accordance with several embodiments of the invention, the explicit random die roll events in a dice game provided as an entertainment game in a gambling hybrid game are rolls of a die or dice. The results of the die roll event are harnessed to drive gambling events in a gambling game in concert with the play of the dice game. For purposes of this discussion, a gambling hybrid game that uses the random events in an entertainment game to determine the results of the gambling event and/or wagers on the gambling event are referred to as a Gambling Integrated Game (GIG). A GIG uses the random events inherent in the underlying entertainment game as a gambling game where the outcome of a random event or a set of random events in the entertainment game is linked to the provisions of awards to a player. Examples of awards in accordance with embodiments of the invention include, but are not limited to, in-game objects, the alteration of in-game variables, and the allocation of credits to one or more pools being collected by the game operator (i.e. casino). A flow diagram of a process for providing a gambling hybrid game with a GIG based upon a dice game in accordance with embodiments of the invention is illustrated in FIG. 14.

In process 1400, the player begins play of the gambling hybrid game (1405). Upon starting the game, the player selects (1410) between using either a player account to provide Real World Credits (RWC) and/or game world credits (GWC) for play (1412) or may play a stand-alone or host version (1411) of the game in which RWC and/or GWC is entered on a per-play basis. Regardless of the selected type of game play, the player then chooses the denominations or wagering amount to use during game play (1415). The ESE then provides the game play of the dice game (1420). During game play of the dice game, the player initiates a die roll event that may be a roll of one or more die (1425).

The results of the die roll event are generated; and the awards and/or wager results in the gambling game based upon the results of the roll event are determined. The results of the wagers and/or awards are provided to the player and displayed as part of the game play (1435). For example, a gambling hybrid game with a gambling integrated game provides a board game with dice rolls, such as a computerized version of the game of Monopoly®, as the entertainment game. In the game, a player rolls two 6-sided die during a die roll event in each player turn. In addition to dictating how far the player moves his piece along a game board in the board game, the die roll event determines which one of the 36 possible permutations (where die 1 and die 2 are called out separately) or 21 permutations (where only sum of the dice is called out) corresponds to a specific monetary payout relative to the credits committed to the gambling game before the dice were “rolled” in a GIG version of the board game, such as Monopoly®. In accordance with some embodiments of a Monopoly® GIG, each of the 36 or 21 possible permutations correspond to at least one of a payout to the player, a possible allocation to a bonus pool, the alteration of an in-game variable, a loss of funds by the player, and a gain of funds by the player.

In accordance with some embodiments, the results of wagers and/or awards can include, but are not limited to contribution to a bonus pool that is awarded as a function of subsequent random events; a RC win for the player; a RC loss for the player; a RC draw for the player; a contribution to a bonus pool that is awarded as a function of player skill and/or as a function of a player's performance in one or more instances of the entertainment game; a contribution to an interstitial credit, such as Quanta, that the player can use in the current game session and/or over multiple game sessions to alter entertainment game variables; a contribution to a specific entertainment game variable without player selection or input; and a contribution to a bonus pool that is applied to a subsequent competition or tournament that the player may or may not become eligible to enter based upon factors including, but not limited to, the demonstrated skill of the player in the entertainment game, money committed to the gambling game, hours spent playing the game, and player club status. In accordance with some embodiments, the award and/or wager may be provided in lieu of the random event affecting the entertainment game. For example, the player may gain the ability to move their piece or one of the above effects may take place in a gambling hybrid game providing a Monopoly® game as an entertainment game in accordance with an embodiment of the invention. In accordance with the embodiment, the results of the die roll event may be affected by direct allocation of each possible random outcome to one of the above mentioned outcomes in a gambling game or a move in the entertainment game. For example, a first die roll of a “2” and a second die roll of a “5” may result in a RC win and no longer provide a move of seven squares in the Monopoly game. In accordance with some embodiments, an addition of an additional random number generating element (a third die for example) is introduced into the dice game that causes the fundamental random number generating element (the two dice) to be interpreted as either a conventional move in the underlying entertainment game, or instead as one of the above effects. In accordance with a number of embodiments, the impact of the underlying explicit random number generating mechanism in the entertainment game may be accumulated over multiple occurrences of the explicit random events in the entertainment game. For example, rather than the outcome of a single roll of the dice by a player during a player turn in the board game which would limit the outcome to one of 36 distinct outcomes, the results of multiple dice rolls accumulated across several turns may be considered at one time so that a greater number of permutations of the result are possible. For example, six rolls of the two dice by a single player or the rolls from six player turns may be used to drive the Random Effect to provide 612 possible outcomes. After the results of the roll are determined and displayed, game play of the entertainment game continues (1440).

Although specific processes for providing gambling hybrid games with a GIG based upon a dice game are discussed above with respect to FIG. 14, any of a variety of processes for providing a gambling hybrid game with a GIG based upon a dice game can be utilized as appropriate to the requirements of specific applications in accordance with embodiments of this invention.

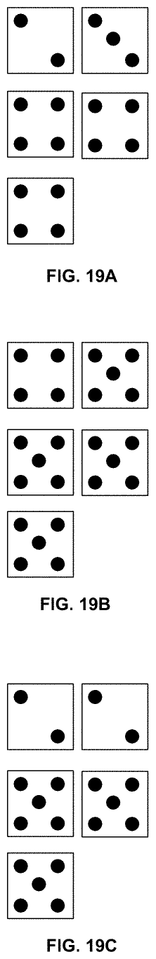

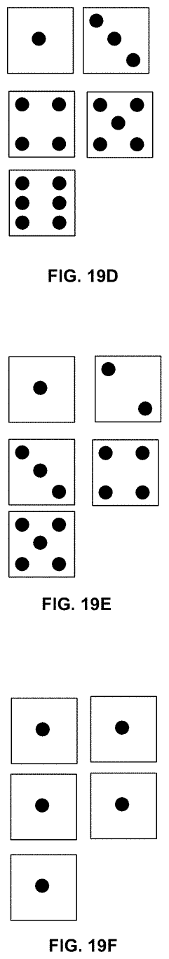

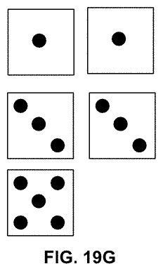

### Gambling Hybrid Game Including a Gambling Integrated Dice Based Game

| Category | Description | Score | Example |
|---|---|---|---|
| Three-Of- | At least three dice showing the | Sum of | FIG. 19A |
| A-Kind | same face | all dice | |
| Four-Of-A- | At least four dice showing the | Sum of | FIG. 19B |
| Kind | same face | all dice | |
| Full House | A three-of-a-kind and a pair | 25 | FIG. 19C |
| Small | Four sequential dice | 30 | FIG. 19D |
| Straight | (1-2-3-4, 2-3-4-5, or 3-4-5-6) | | |
| Large | Five sequential dice | 40 | FIG. 19E |
| Straight | (1-2-3-4-5 or 2-3-4-5-6) | | |
| DICE | All five dice showing the same | 50 First | FIG. 19F |
| COMBO | face | DICE | |
| | | COMBO | |
| | | only | |
| Chance | Any combination often acts as | Sum of | FIG. 19G |
| | discard box for a turn that will | all dice | |
| | not fit in another category | | |
| | (thus the name), although during | | |
| | a lucky game it can be used to | | |
| | record a high score | | |

In accordance with some embodiments, a gambling hybrid game can include a GIG based upon a dice based game as the entertainment game. One example of a dice based game is Yahtzee® by Hasbro Inc. of Pawtucket, R.I. In other embodiments, any of a variety of dice based entertainment games can serve as a GIG within a gambling hybrid game. In accordance with many embodiments, the gambling hybrid game drives gambling events off the random nature of a player rolling a set of five dice during a roll event during each player turn. The odds for the resulting combinations of dice are known for each turn. For example, a roll of (5) sixes has a 0.0129% likelihood of occurring. Thus, a gambling proposition can be tied to each roll of the dice in the die roll event based on the know combinations. A pay table can be constructed for any combination of resulting dice rolls in the die roll event. A specific payout for each such combination or permutation of dice rolls, including but not limited to those that are considered relevant to a Dice based game. The following table shows the scoring combination of dice results from the roll of 5 dice of a die roll event in Yahtzee®.

A specific payout can be established for each of the above categories. For example, a player may gain a 50× credit multiple on a DICE COMBO, but a 100× credit multiple on a DICE COMBO of all ones. In some embodiments of a gambling hybrid game includes a GIG based upon a dice game, there can also be a limit to the payouts that a player can gain for any given category. For example, once the player has achieved a three of a kind, the player may no longer be able to obtain a payout on that outcome of the dice roll. At the same time, however, in a number of embodiments of a gambling hybrid game includes a GIG based upon a dice game, the payout associated with achieving the other categories can be altered to reflect the lower probability of getting a winning dice roll during the die roll event after one or more categories have been closed out. For example, the “Chance” category could, have a zero payout.

In a traditional dice game, such as Yahtzee®, the player gets to roll the set of five dice three times during a turn providing three die roll events. In accordance with many embodiments of the invention, gambling can be initiated in the gambling hybrid game including a GIG for each die roll event for the set of dice and/or the combined results of the three separate die roll events. For example, a combination achieved on the first die roll event (a probability of about 0.000772) could pay out a substantially higher number of credits than one combination achieved using the die roll events (a probability of about 0.04603). As can readily be appreciated, any number of die roll events and/or combinations of die roll events within the entertainment game can be utilized in the gambling game.

In the accordance with an embodiment of a gambling hybrid game providing a GIG based upon a dice game, such as Yahtzee®, players achieve a GWC score using the conventional rules of the dice game in which the categories and bonus points accumulated over thirteen turns are considered. The gambling game launched as a function of the three dice rolls per turn (either singularly or in aggregate) can provide a direct RC return and/or an in-game benefit that is not in terms of RC. For example, the in-game benefit may be a direct result of the gambling game; or a secondary effect of the RC won or lost in the gambling game where RC applied formulaically to derive the in-game benefit to be provided. Examples of an in-game benefit that are not RC include, but are not limited to, the opportunity to roll a single die one more time at the conclusion of a turn and to “forcibly” convert one die to a number of your choice at the conclusion of your turn.

Provision of a Gambling Hybrid Game Including a Gig Based Upon a Dice Game

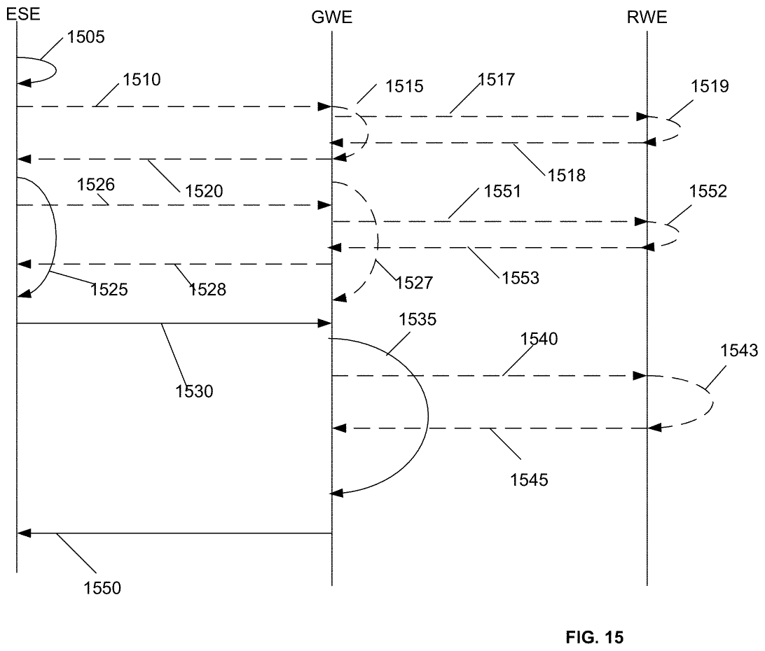

In accordance with several embodiments of this invention, the ESE, GWE, and RWE provide a gambling hybrid game including a GIG based upon a dice game. A timing chart showing the processes performed by the ESE, GWE, and RWE and the communications between these components to provide a gambling hybrid game with a GIG based upon a dice game in accordance with an embodiment of this invention is illustrated in FIG. 15. The ESE provides the dice game and detects that a roll event including rolls for one or more die is to occur in the dice game (1505). Upon detecting that the die roll event is to occur, the ESE may optionally request gambling information that may include odds of particular results and/or payouts for the die roll event in GIG from the GWE (1510). In response to the request, the GWE determines gambling information that may include the odds of particular results and/or payouts information for the random event (1515) and provides the gambling information to the ESE (1520). In a number of embodiments, the GWE may request the gambling information from the RWE (1517). In response to the request, the RWE determines gambling information. The gambling information may the odds and/or payout information from tables maintained in the RWE (1519) in accordance with some embodiments. The RWE provides the determined gambling information to the GWE (1518).

The ESE then executes one or more die rolls to determine the results of the die event in the dice game to generate die roll event results (1525). In accordance with a number of embodiments, the GWE detects the execution of the one or more dice roles 1526 and performs (1527) a corresponding process of requesting 1551 that the RWE execute (1552) a dice roll and return the dice roll as a gambling result 1553 to the GWE for each of the one or more dice rolls. The GIG determines the results of a current roll based upon one or more rolls of each die of a set of die by the player and the RWE provides the results of a current roll to the GWE. The GWE may then update the gambling information, which may include updates of the odds of particular results and/or payouts based upon the results of the current roll (1527) and provides the updated gambling information to the ESE for display (1528). When the die roll event is completed and the results of the die roll event are determined, the ESE provides the entertainment play results of the die roll event to the GWE (1530). The GWE uses the entertainment game die roll results of the die roll event to determine an entertainment game result for the die roll event (1535). The entertainment game result may be an award based on the results of the die roll event and/or the results of wagers on the outcome of the one or more die rolls in the die roll event. To determine the entertainment game result, the GWE may provide the die roll event results to the RWE (1540). The RWE uses tables stored by the RWE to determine the entertainment game result based on the die roll event results (1543) and provides the entertainment game result results to the GWE (1545). After the entertainment game result is determined, the gambling result is provided by the GWE to the ESE (1550). The ESE can then incorporate the entertainment game result into the entertainment game and/or display the gambling display in an interface for the player.

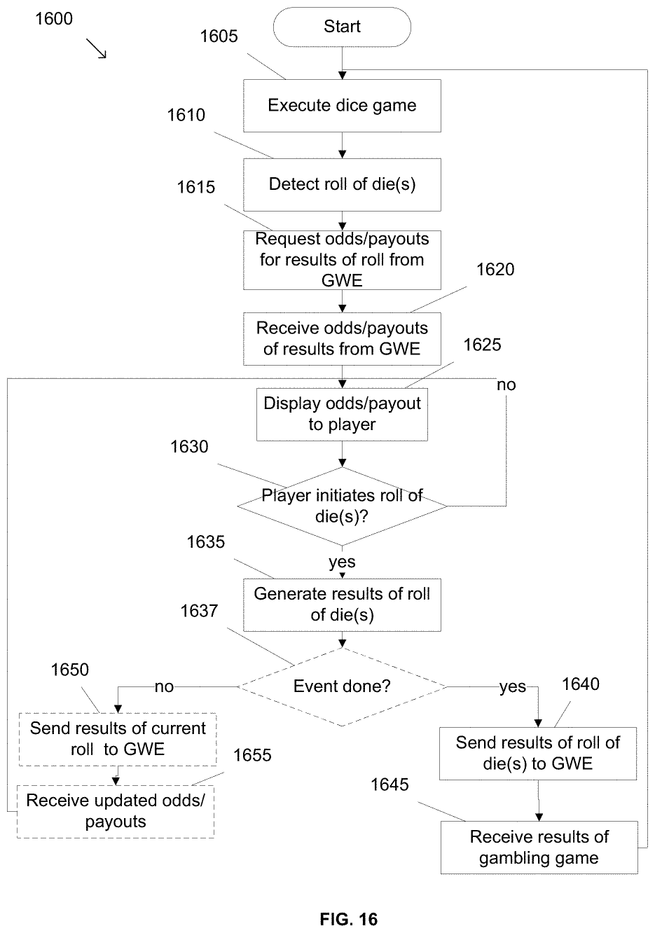

A process performed by an ESE as part of a process of providing a gambling hybrid game including a GIG based upon a dice game in accordance with an embodiment of the invention is shown in FIG. 16. In process 1600, the ESE executes the dice game as an entertainment game (1605). During execution of the dice game, the ESE detects the occurrence of a die roll event involving a roll of the one or more die (1610). In accordance with many embodiments, the ESE requests (1615) and receives (1620) the odds of particular results and payouts based upon the results for the die roll event from the GWE. The received odds and/or payouts are displayed by the ESE for the player (1625) and the player may initiate a roll of the one or more die in the die roll event (1630). The ESE determines the results of the initiated roll of the one or more die (1635). In accordance with a many embodiments, the die roll event may include the opportunity for multiple rolls of the one or more die. In accordance with many of the embodiments, the ESE determines whether the multiple rolls are completed (1637). In several embodiments, the ESE uses an RWE to determine the results of the initiated roll of the one or more die. If the multiple roles are not completed, the ESE may provide the result of a current roll of the one or more die to the GWE (1650) and receive updated odds for particular results and payouts of the die roll event based on the results determined based upon the current roll. Process 1600 is then repeated by displaying the updated odds and/or payouts (1625) and the player being allowed to initiate a subsequent die roll of the one or more die. If the multiple rolls are complete, the ESE provides the results of the multiple rolls to the GWE (1640), receives any gambling results that may affect the dice game (1645), and repeats process 1600 to continue executing the dice game including any updates to the dice game based upon the gambling results.

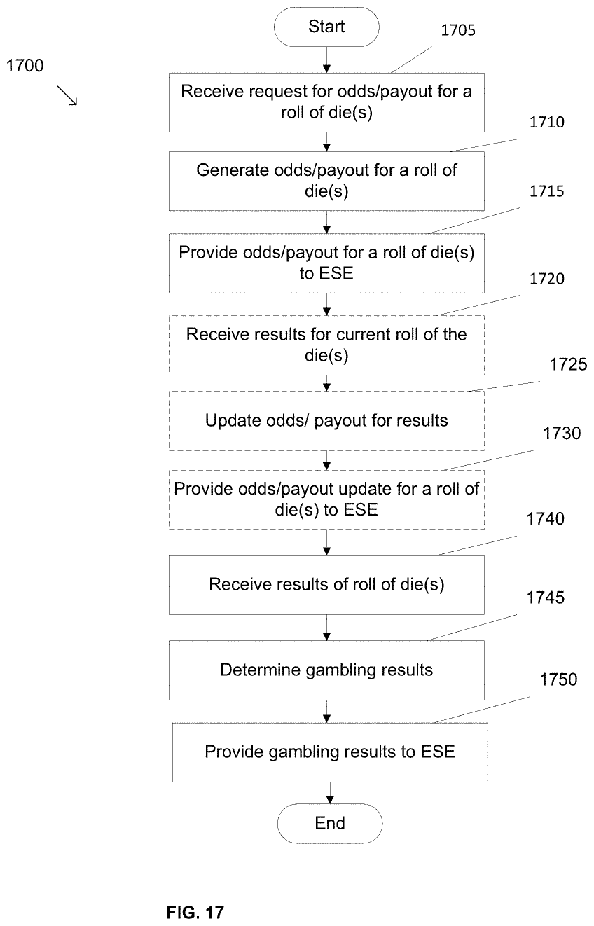

A process performed by the GWE to provide a gambling hybrid game including a GIG based upon a dice game in accordance with an embodiment of the invention is shown in FIG. 17. In process 1700, the GWE receives a request for gambling information for a die event. The gambling information may include the odds of particular results and/or payouts for the results for a roll of the one or more die (1705). The GWE generates gambling information for the die roll event (1710) and provides gambling information to the ESE (1715). In accordance with some embodiments, the GWE requests the gambling information for the die event from the RWE. In accordance with a number of embodiments, the GWE may receive the results of a current roll of one or more die in the die roll event use the results of the current die roll to determine updates to the gambling information (1725). The update may then be provided to the ESE (1730) for display to the player.

The GWE receives the results of the die roll event from the ESE (1740) and determines the gambling results based upon the results of the die roll event (1745). The gambling results that affect the entertainment game are then provided to the ESE (1750) and/or are the gambling results provided to an interface for display to the player. Process 1700 then ends.

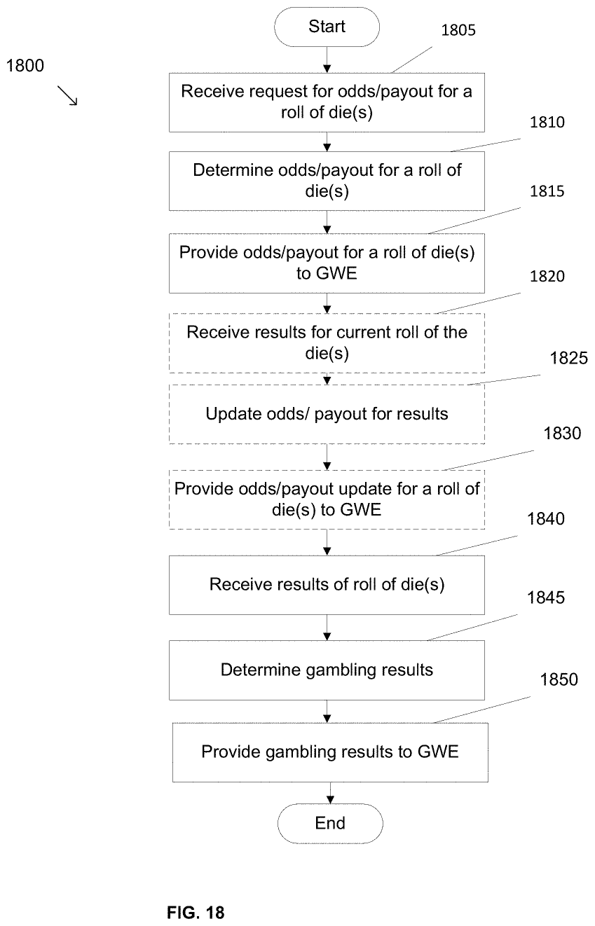

In accordance with some embodiments, the determination of odds and/or payouts based upon the roll(s) of the die or dice is determined by RWE. A process performed by the RWE to provide a gambling hybrid game including a GIG based upon a dice game in accordance with an embodiment of the invention is shown in FIG. 18. In process 1800, the RWE receives a request for gambling information for a die roll event from the GWE (1805). The RWE determines gambling information that may include the odds of the particular results and/or payouts based upon the results (1810). In accordance with a number of embodiments, the odds and/or payouts may be read from a table stored by the RWE that provides the odds of the particular results and/or the payouts for the results of a die roll event. In many embodiments, the results and/or payouts may be determined by an algorithm performed by the RWE. The determined gambling information is provided by the RWE to the GWE (1815).

In accordance with several embodiments, the gambling results are determined based upon a set of rolls in the die roll event. In these embodiments, the RWE may receive the result of a current roll of one or more die in a set of die rolls in the die roll event from the GWE (1820) and determine updates for the gambling information that may include odds of particular results and/or payouts based upon the results of the current roll (1825). The updated gambling information provided to the GWE.

In process 1800, the results of the die roll event are provided to the RWE (1840) after the ESE has determined the results of each of the rolls of one or more die affecting the gambling result based upon the die roll event. The RWE then determines the gambling results based upon the results of the die roll event (1845) and provides the gambling results to the GWE (1850).

Although certain specific features and aspects of a gaming system have been described herein, many additional modifications and variations would be apparent to those skilled in the art. For example, the features and aspects described herein may be implemented independently, cooperatively or alternatively without deviating from the spirit of the disclosure. It is therefore to be understood that a hybrid gaming system may be practiced otherwise than as specifically described. Thus, the foregoing description of the hybrid gaming system should be considered in all respects as illustrative and not restrictive, the scope of the claims to be determined as supported by this disclosure and the claims' equivalents, rather than the foregoing description.

What is claimed is:

1. A system for providing a gambling hybrid game including a gambling integrated game that provides a dice game as an entertainment game, comprising:
a currency input device;
a mobile device constructed to:
execute the dice game as the entertainment game;
detect a die roll event is to occur during execution of the dice game;
request, from the game world server, odds for the die roll event;
display the odds for the die roll event to the player;
accept player instructions to resolve the die roll event;
resolve the die roll event to generate a die roll event result wherein the die roll event includes a roll of one or more die;
communicate, to the game world server, the die roll event result and an occurrence of a gambling event in a gambling game based on play of the entertainment game;
communicate, to the game world server, a request for gambling information for the die roll event;
receive, from the game world server, a result of the gambling event;
receive, from the game world server, the gambling information for the die roll event;
display, to the player, the result of the gambling event; and
display the gambling information to the player during execution of the dice game;
a real world server, connected to the game world server, constructed to:
receive, from the game world server, a request for a resolution of the gambling event and the die roll event result;
determine a result of the gambling event based on the die roll event result; and
communicate, to the game world server, the result of the gambling event; and
the game world server, connected to the mobile device and connected to the real world server, constructed to:
manage the entertainment game;
monitor the mobile device for the die roll event result and an occurrence of a gambling event in a gambling game based on play of the entertainment game;
receive, from the mobile device, the request for the odds for the die roll event;
generate the odds for the die roll event;
receive, from the mobile device, the die roll event result and the occurrence of the gambling event in the gambling game based on play of the entertainment game;
communicate, to the real world server, the request for the resolution of the gambling event and the die roll event results;
receive, from the real world server, the result of the gambling event; and
communicate, to the mobile device, the result of the gambling event.

2. The system of claim 1, wherein the mobile device is a smartphone.

3. The system of claim 1, wherein the game world server is further constructed to:
generate the gambling information for the die roll event.

4. The system of claim 3, wherein the real world server is further constructed to:
receive, from the game world server, a request for a gambling information for the die roll event;
determine the gambling information for the die roll event; and
communicate, to the game world server, the gambling information for the die roll event.

5. The system of claim 1, wherein the die roll event includes a plurality of rolls of one or more die and the mobile device determines a current roll result for each of the plurality of die rolls in the dice roll event during execution of the dice game and the game world server uses the current roll result for each of the plurality of rolls to determine a gambling result based upon the die roll event.

6. The system of claim 5, wherein the mobile device is further constructed to:
determine the current roll result for one of the plurality of rolls of the die event;
communicate, to the game world server, the current roll result; and
receive from the game world server, the update of the gambling information.

7. The system of claim 6, wherein the game world server is further constructed to:
determine an update of the gambling information based upon the current roll result; and
communicate, to the mobile device, the update of the gambling information.

8. A system for providing a gambling hybrid game including a gambling integrated game that provides a dice game as an entertainment game, comprising:
a currency input device;
a mobile device, connected to a game world server and constructed to:
execute the dice game as the entertainment game;
detect a die roll event is to occur during execution of the dice game;
request, from the game world server, odds for the die roll event;
display the odds for the die roll event to the player;
accept player instructions to resolve the die roll event;
resolve the die roll event to generate a die roll event result wherein the die roll event includes a roll of one or more die;
communicate, to the game world server, the die roll event result and an occurrence of a gambling event in a gambling game based on play of the entertainment game;
communicate, to the game world server, a request for gambling information for the die roll event;
receive, from the game world server, a result of the gambling event;
receive, from the game world server, the gambling information for the die roll event;
display, to the player, the result of the gambling event; and
display the gambling information to the player during execution of the dice game; and
the game world server, connected to the mobile device and connected to a real world server, constructed to:
manage the entertainment game;
monitor the mobile device for the die roll event result and an occurrence of a gambling event in a gambling game based on play of the entertainment game;
receive, from the mobile device, the request for the odds for the die roll event;
generate the odds for the die roll event;
receive, from the mobile device, the die roll event result and the occurrence of the gambling event in the gambling game based on play of the entertainment game;
communicate, to the real world server, the request for the
resolution of the gambling event and the die roll event results;
receive, from the real world server, the result of the gambling event; and
communicate, to the mobile device, the result of the gambling event.

9. The system of claim 8, wherein the mobile device is a smartphone.

10. The system of claim 8, wherein the game world server is further constructed to:
generate the gambling information for the die roll event.

11. The system of claim 10, wherein the real world server is further constructed to:
receive, from the game world server, a request for the gambling information for the die roll event;
determine the gambling information for the die roll event; and
communicate, to the game world server, the gambling information for the die roll event.

12. The system of claim 8, wherein the die roll event includes a plurality of rolls of one or more die and the mobile device determines a current roll result for each of the plurality of die rolls in the dice roll event during execution of the dice game and the game world server uses the current roll result for each of the plurality of rolls to determine a gambling results based upon the die roll event.

13. The system of claim 12, wherein the mobile device is further constructed to:
determine the current roll result for one of the plurality of rolls of the die event;
communicate, to the game world server, the current roll result; and
receive from the game world server, the update of the gambling information.

14. The system of claim 13, wherein the game world server is further constructed to:
determine an update of the gambling information based upon the current roll result; and
communicate, to the mobile device, the update of the gambling information.

15. A system for providing a gambling hybrid game including a gambling integrated game that provides a dice game as an entertainment game, comprising:
a currency input device, wherein a player inserts money to enable play of the gambling hybrid game;
a real world server, connected to a game world server, constructed to:
receive, from the game world server, a request for a resolution of a gambling event and a die roll event result;
determine a result of the gambling event based on the die roll event result; and
communicate, to the game world server, the result of the gambling event; and
the game world server, connected to a mobile device and connected to the real world server, constructed to:
manage the entertainment game;
monitor the mobile device for the die roll event result and an occurrence of the gambling event in a gambling game based on play of the entertainment game;
receive, from the mobile device, a request for odds for the die roll event;
generate the odds for the die roll event;
receive, from the mobile device, player instructions to resolve the die roll event;
receive, from the mobile device, the die roll event result and the occurrence of the gambling event in the gambling game based on play of the entertainment game;
receive, from the mobile device, a request for gambling information for the die roll event;
communicate, to the real world server, the request for the resolution of the gambling event and the die roll event results;
receive, from the real world server, the result of the gambling event;
communicate, to the mobile device, the result of the gambling event;
communicate, to the mobile device, the gambling information for the die roll event.

16. The system of claim 15, wherein the mobile device is further constructed to:
detect a die roll event is to occur during execution of the dice game;
communicate, to the game world server, a request for gambling information for the die roll event;
receive, from the game world server, the gambling information for the die roll event; and
display the gambling information to the player during execution of the dice game.

17. The system of claim 16, wherein the game world server is further constructed to:
generate the gambling information for the die roll event.

18. The system of claim 17, wherein the real world server is further constructed to:
receive, from the game world server, a request for the gambling information for the die roll event;
determine the gambling information for the die roll event; and
communicate, to the game world server, the gambling information for the die roll event.

19. The system of claim 15, wherein a die roll event includes a plurality of rolls of one or more die and the mobile device determines a current roll result for each of the plurality of die rolls in the dice roll event during execution of the dice game and the game world server uses the current roll result for each of the plurality of rolls to determine a gambling result based upon the die roll event.

20. The system of claim 19, wherein the mobile device is further constructed to:
determine the current roll result for one of the plurality of rolls of the die event;
communicate, to the game world server, the current roll result; and
receive from the game world server, the update of the gambling information.
